(19) United States
(12) Patent Application Publication
(10) Pub. No.: US 2015/0296247 A1
(43) Pub. Date: Oct. 15, 2015

(54) INTERACTION OF USER DEVICES AND VIDEO DEVICES

(71) Applicant: ExXothermic, Inc., Saratoga, CA (US)

(72) Inventor: Lance Glasser, Saratoga, CA (US)

(21) Appl. No.: 14/749,412

(22) Filed: Jun. 24, 2015

Related U.S. Application Data
(63) Continuation-in-part of application No. 14/538,743, filed on Nov. 11, 2014.
Application No. 14/538,743 is a continuation-in-part of application No. 13/940,115, filed on Jul. 11, 2013.
Application No. 13/940,115 is a continuation of application No. 13/556,461, filed on Jul. 24, 2012, now Pat. No. 8,495,236.
(60) Provisional application No. 61/604,693, filed on Feb. 29, 2012.

(51) Int. Cl. H04N 21/439; H04N 21/436; H04N 21/6587; H04N 21/414; H04N 21/233

(52) U.S. Cl. CPC H04N 21/439; H04N 21/41407; H04N 21/41415; H04N 21/233; H04N 21/6587; H04N 21/436

(57) ABSTRACT

According to various embodiments, a server, which may be a video display device, receives an audio stream that is one of a plurality of audio streams corresponding to one or more video streams. The server indicates that the audio stream is available for access. The server receives a request to access the audio stream. The server transmits the audio stream to a personal user device or a listening device. The audio stream is presented through the listening device so that a user is capable of listening to the audio stream while watching one or more video streams through one or more video display devices.

### CROSS-REFERENCE TO RELATED APPLICATIONS

This patent application is a continuation in part of U.S. patent application Ser. No. 14/538,743, filed Nov. 11, 2014; which was a continuation-in-part of U.S. patent application Ser. No. 13/940,115, filed Jul. 11, 2013, which is a continuation application and claims the benefit of U.S. patent application Ser. No. 13/556,461 filed Jul. 24, 2012 (U.S. Pat. No. 8,495,235, issued Jul. 23, 2013), which claims the benefit of U.S. Provisional Patent No. 61/604,693 filed Feb. 29, 2012. The content of U.S. Provisional Patent No. 61/604,693 is incorporated herein by reference.

### BACKGROUND

A television generally provides both video and audio to viewers. In some situations, such as in a gym, restaurant/bar, airport waiting area, etc., multiple TVs or other video display devices (each with different video content) may be provided for public viewing to multiple clients/patrons in a single large room. If the audio signals of each TV were also provided for public listening in these situations, the noise level in the room would be intolerable and the people would not be able to distinguish the audio from any single TV nor the voices in their own personal conversations. Consequently, it is preferable to mute the audio signals on each of the TVs in these situations in order to prevent audio chaos. Some of the people, however, may be interested in hearing the audio in addition to seeing the video of some of the display devices in the room, and each such person may be interested in the program that's on a different one of the display devices.

One suggested solution is for the close captioning feature to be turned on for some or all of the display devices, so the people can read the text version of the audio for the program that interests them. However, the close captions are not always a sufficient solution for all of the people in the room.

Another suggested solution is for the audio streams to be provided through relatively short-distance or low-power radio broadcasts within the establishment wherein the display devices are viewable. Each display device is associated with a different radio frequency. Thus, the people can view a selected display device while listening to the corresponding audio stream by tuning their radios to the proper frequency. Each person uses headphones or earbuds or the like for private listening. For this solution to work, each person either brings their own radio or borrows/rents one from the establishment.

In another solution in an airplane environment, passengers are provided with video content on display devices while the associated audio is provided through a network. The network feeds the audio stream to an in-seat console such that when a user plugs a headset into the console, the audio stream is provided for the user's enjoyment.

### SUMMARY

In some embodiments, the present invention involves a server receiving an audio stream that is one of a plurality of audio streams received by the server, the plurality of audio streams corresponding to a plurality of video streams available for simultaneous viewing on a plurality of video display devices within an environment; the server indicating that the audio stream is available for access; the server receiving a request to access the audio stream from a personal user device that is within the environment, the personal user device running an application, the personal user device being physically distinct from the plurality of video display devices, and the personal user device including or being connected to a listening device that is distinct from the plurality of video display devices; and the server transmitting the audio stream to the personal user device; and wherein the application running on the personal user device presents the audio stream through the listening device so that a user is capable of listening to the audio stream through the personal user device while watching the plurality of video streams through the plurality of video display devices.

In some embodiments, the present invention involves a video display device receiving a plurality of audio streams, the plurality of audio streams corresponding to at least one video stream presented for viewing on the video display device within an environment; the video display device indicating that the plurality of audio streams are available for access; the video display device receiving a request to access a selected one of the plurality of audio streams; and the video display device transmitting the selected one of the plurality of audio streams to a listening device that is physically distinct from the video display device; wherein a user is capable of listening to the selected one of the plurality of audio streams through the listening device while watching the at least one video stream through the video display device.

In some embodiments, the present invention involves a plurality of video display devices receiving a plurality of audio streams and a plurality of video streams, each of the plurality of video display devices receiving an audio stream that is one of the plurality of audio streams and a video stream that is one of the plurality of video streams, the plurality of video streams being available for viewing on the plurality of video display devices within an environment; the plurality of video display devices indicating that the plurality of audio streams are available for access; a video display device receiving a request to access the audio stream that the video display device receives, the video display device being one of the plurality of video display devices; and in response to the request, the video display device transmitting the audio stream that the video display device receives to a listening device that is physically distinct from the plurality of video display devices; wherein a user is capable of listening to the audio stream transmitted by the video display device through the listening device while watching the corresponding video stream received by the video display device.

In some embodiments, the present invention involves an application (running on a personal user device) determining a plurality of audio streams that are available for streaming through the personal user device from at least one video display device that is physically distinct from the personal user device, the application being stored within a memory of the personal user device, the plurality of audio streams corresponding to at least one video stream available for viewing within an environment, wherein the at least one video stream is associated with the at least one video display device; the application receiving a selection of one of the audio streams from a user, the user having input the selection of the one selected audio stream via the personal user device; the application transmitting to the at least one video display device a request to access the one selected audio stream; the application receiving the one selected audio stream; and the application providing the one selected audio stream through a listening device included in or connected to the personal user device, so that the user is capable of listening to the one selected audio stream through the personal user device while watching the at least one video stream associated with the at least one video display device, the listening device being distinct from the at least one video display device.

In some embodiments, the video streams are delayed relative to the audio streams at the audio-video source and synchronized at a downstream device. In some embodiments, the audio streams are transmitted to listening devices through the personal user devices or directly to the listening devices bypassing the personal user devices. In some embodiments involving more than one video display device, one of the video display devices aggregates data for a combined plurality of the audio streams. In some embodiments, a plurality of audio streams correspond to a single video stream.

### BRIEF DESCRIPTION OF THE DRAWINGS

FIG. 1 is a simplified schematic drawing of an environment incorporating audio-video (A/V) equipment in accordance with an embodiment of the present invention.

FIGS. 2 and 3 are simplified examples of signs or cards that may be used in the environment shown in FIG. 1 to provide information to users therein according to an embodiment of the present invention.

FIGS. 4-18 are simplified examples of views of a user interface for an application for use with the A/V equipment shown in FIG. 1 in accordance with an embodiment of the present invention.

FIG. 19 is a simplified schematic diagram of at least some of the A/V equipment that may be used in the environment shown in FIG. 1 in accordance with an embodiment of the present invention.

FIG. 20 is a simplified diagram of functions provided through at least some of the A/V equipment used in the environment shown in FIG. 1 in accordance with an embodiment of the present invention.

FIG. 21 is a simplified schematic diagram of a network incorporating the environment shown in FIG. 1 in accordance with an embodiment of the present invention.

FIG. 22 is a simplified schematic diagram of a system that may be used in the environment shown in FIG. 1 in accordance with another embodiment of the present invention.

FIG. 23 is a simplified schematic diagram of at least part of an audio subsystem for use in the system shown in FIG. 22 in accordance with another embodiment of the present invention.

FIG. 24 is a simplified flow chart of an example process for at least some of the functions of servers and user devices that may be used in the environment shown in FIG. 1 in accordance with another embodiment of the present invention.

FIG. 25 is a simplified example of a view of a user interface for an application for use with the A/V equipment shown in FIG. 1 in accordance with another embodiment of the present invention.

FIG. 26 is a simplified schematic diagram of at least some of the A/V equipment that may be used in the environment shown in FIG. 1 in accordance with another embodiment of the present invention.

FIG. 27 is a simplified schematic diagram of an example video device that may be used in the environment shown in FIG. 1 in accordance with another embodiment of the present invention.

FIGS. 28-31 are simplified examples of views of a user interface for an application for use with the A/V equipment shown in FIG. 26 in accordance with another embodiment of the present invention.

### DETAILED DESCRIPTION

In some embodiments, the solution described herein allows a user to utilize a personal portable device such as a smartphone to enjoy audio associated with a public display of video. The portable device utilizes a software application to provide the association of audio with the public video. Therefore, the present solution does not require very specific hardware within the seats or chairs or treadmills or nearby display devices, so it is readily adaptable for a restaurant/bar or other establishments.

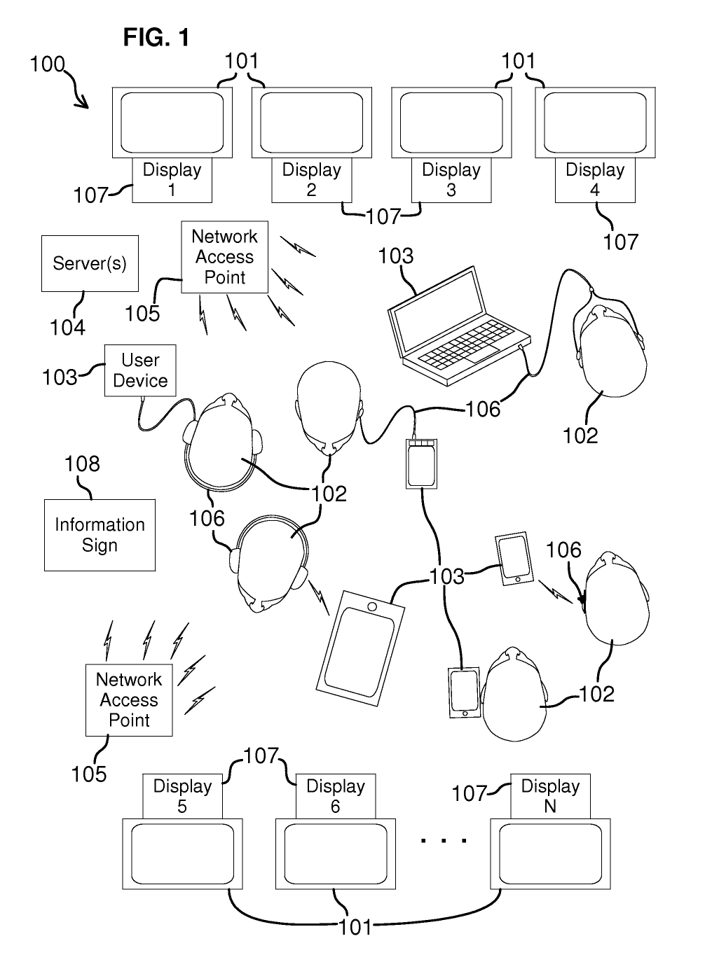

An environment 100 incorporating a variety of audio-video (A/V) equipment in accordance with an embodiment of the present invention is shown in FIG. 1. In general, the environment 100 includes one or more video display devices 101 available for viewing by multiple people/users 102, at least some of whom have any one of a variety of user devices that have a display (the user devices) 103. Video streams (at least one per display device 101), such as television programs, Internet-based content, VCR/DVD/Blue-ray/DVR videos, etc., are generally provided through the display devices 101. The users 102 may thus watch as many of the video streams as are within viewing range or as are desired. Additionally, multiple audio streams corresponding to the video streams (generally at least one for each different video stream) are made available through a network (generally including one or more servers 104 and one or more network access points 105) accessible by the user devices 103. The users 102 who choose to do so, therefore, may select any available audio stream for listening with their user devices 103 while watching the corresponding video stream on the corresponding display device 101.

The environment 100 may be any place where video content may be viewed. For example, in some embodiments, the environment 100 may be a public establishment, such as a bar/pub, restaurant, airport lounge/waiting area, medical waiting area, exercise gym, outdoor venue, concert arena, drive-in movie theater or other establishment that provides at least one display device 101 for customer or public viewing. Users 102 with user devices 103 within the establishment may listen to the audio stream associated with the display device 101 of their choice without disturbing any other people in the same establishment. Additionally, picture-in-a-picture situations may have multiple video streams for only one display device 101, but if the audio streams are also available simultaneously, then different users 102 may listen to different audio streams. Furthermore, various features of the present invention may be used in a movie theater, a video conferencing setting, a distance video-learning environment, a home, an office or other place with at least one display device 101 where private listening is desired. In some embodiments, the environment 100 is an unstructured environment, as differentiated from rows of airplane seats or even rows of treadmills, where a user may listen only to the audio that corresponds to a single available display device.

According to some embodiments, the user devices 103 are multifunctional mobile devices, such as smart phones (e.g., iPhones™, Android™ phones, Windows Phones™, BlackBerry™ phones, Symbian™ phones, etc.), cordless phones, notebook computers, tablet computers, Maemo™ devices, MeeGo™ devices, personal digital assistants (PDAs), iPod Touches™, handheld game devices, audio/MP3 players, etc. Unlike for the prior art solution, described above, of using a radio to listen to the audio associated with display devices, it has become common practice in many places for people to carry one or more of the mobile devices mentioned, but not a radio. Additionally, whereas it may be inconvenient or troublesome to have to borrow or rent a radio from the establishment/environment 100, no such inconvenience occurs with respect to the mobile devices mentioned, since users 102 tend to always carry them anyway. Furthermore, cleanliness and health issues may arise from using borrowed or rented headphones, and cost and convenience issues may arise if the establishment/environment 100 has to provide new headphones or radio receivers for each customer, but no such problems arise when the users 102 all have their own user devices 103, through which they may listen to the audio. As such, the present invention is ideally suited for use with such mobile devices, since the users 102 need only download an application (or app) to run on their mobile device in order to access the benefits of the present invention when they enter the environment 100 and learn of the availability of the application. However, it is understood that the present invention is not necessarily limited only to use with mobile devices. Therefore, other embodiments may use devices that are typically not mobile for the user devices 103, such as desktop computers, game consoles, set top boxes, video recorders/players, land line phones, etc. In general, any computerized device capable of loading and/or running an application may potentially be used as the user devices 103.

In some embodiments, the users 102 listen to the selected audio stream via a set of headphones, earbuds, earplugs or other listening device 106. The listening device 106 may include a wired or wireless connection to the user device 103. Alternatively, if the user device 103 has a built-in speaker, then the user 102 may listen to the selected audio stream through the speaker, e.g., by holding the user device 103 next to the user's ear or placing the user device 103 near the user 102.

The display devices 101 may be televisions, computer monitors, all-in-one computers or other appropriate video or A/V display devices. In some embodiments, the audio stream received by the user devices 103 may take a path that completely bypasses the display devices 101, so it is not necessary for the display devices 101 to have audio capabilities. However, if the display device 101 can handle the audio stream, then some embodiments may pass the audio stream to the display device 101 in addition to the video stream, even if the audio stream is not presented through the display device 101, in order to preserve the option of sometimes turning on the audio of the display device 101. Additionally, if the display device 101 is so equipped, some embodiments may use the audio stream from a headphone jack or line out port of the display device 101 as the source for the audio stream that is transmitted to the user devices 103. Furthermore, in some embodiments, some or all of the functions described herein for the servers 104 and the network access points 105 may be built in to the display devices 101, so that the audio streams received by the user devices 103 may come directly from the display devices 101.

According to some embodiments, each user device 103 receives a selected one of the audio streams wirelessly. In these cases, therefore, the network access points 105 are wireless access points (WAPs) that transmit the audio streams wirelessly, such as with Wi-Fi, Bluetooth™, mobile phone, fixed wireless or other appropriate wireless technology. According to other embodiments, however, the network access points 105 use wired (rather than wireless) connections or a combination of both wired and wireless connections, so a physical cable may connect the network access points 105 to some or all of the user devices 103. The wired connections, however, may be less attractive for environments 100 in which flexibility and ease of use are generally desirable. For example, in a bar, restaurant, airport waiting area or the like, many of the customers (users 102) will likely already have a wireless multifunction mobile device (the user device 103) with them and will find it easy and convenient simply to access the audio streams wirelessly. In some embodiments, however, one or more users 102 may have a user device 103 placed in a preferred location for watching video content, e.g., next to a bed, sofa or chair in a home or office environment. In such cases, a wired connection between the user device 103 and the server 104 may be just as easy or convenient to establish as a wireless connection.

Each server 104 may be a specially designed electronic device having the functions described herein or a general purpose computer with appropriate peripheral devices and software for performing the functions described herein or other appropriate combination of hardware components and software. As a general purpose computer, the server 104 may include a motherboard with a microprocessor, a hard drive, memory (storing software and data) and other appropriate subcomponents and/or slots for attaching daughter cards for performing the functions described herein. Additionally, each server 104 may be a single unit device, or the functions thereof may be spread across multiple physical units with coordinated activities. In some embodiments, some or all of the functions of the servers 104 may be performed across the Internet or other network or within a cloud computing system.

Furthermore, according to different embodiments, the servers 104 may be located within the environment 100 (as shown in FIG. 1) or off premises (e.g., across the Internet or within a cloud computing system). If within the environment 100, then the servers 104 generally represent one or more hardware units (with or without software) that perform services with the A/V streams that are only within the environment 100. If off premises, however, then the servers 104 may represent a variety of different combinations and numbers of hardware units (with or without software) that may handle more than just the A/V streams that go to only one environment 100. In such embodiments, the servers 104 may service any number of one or more environments 100, each with its own appropriate configuration of display devices 101 and network access points 105. Location information from/about the environments 100 may aid in assuring that the appropriate audio content is available to each environment 100, including the correct over-the-air TV broadcasts.

The number of servers 104 that service any given environment 100 (either within the environment 100 or off premises) is generally dependent on a variety of factors including, but not limited to, the number of display devices 101 within the environment 100, the number of audio or A/V streams each server 104 is capable of handling, the number of network access points 105 and user devices 103 each server 104 is capable of servicing and the number of users 102 that can fit in the environment 100. Additionally, the number of network access points 105 within any given environment 100 is generally dependent on a variety of factors including, but not limited to, the number of display devices 101 within the environment 100, the size of the environment 100, the number of users 102 that can fit in the environment 100, the range of each network access point 105, the bandwidth and/or transmission speed of each network access point 105, the degree of audio compression and the presence of any RF obstructions (e.g., walls separating different rooms within the environment 100). In some embodiments, there may even be at least one server 104 and at least one network access point 105 connected at each display device 101.

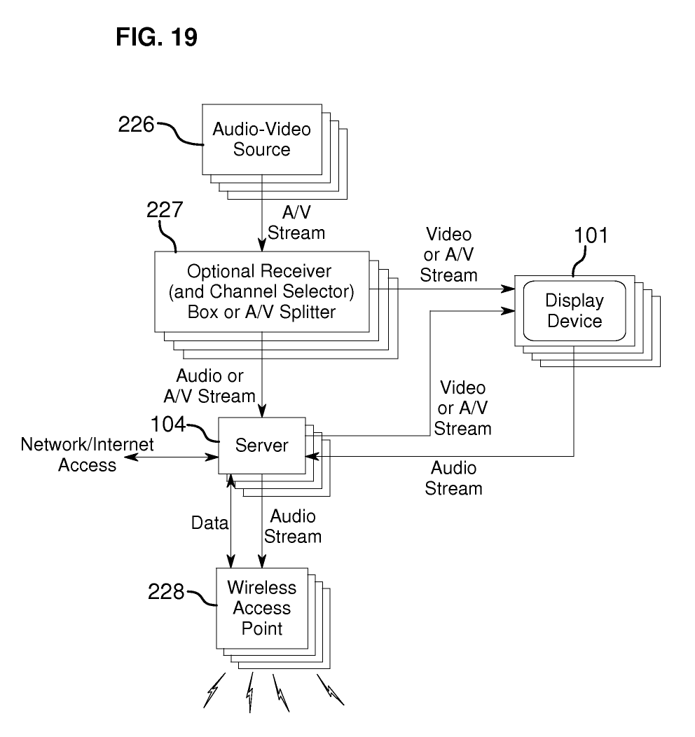

Each server 104 generally receives one or more audio streams (and optionally the corresponding one or more video streams) from an audio or A/V source (described below). The servers 104 also generally receive (among other potential communications) requests from the user devices 103 to access the audio streams. Therefore, each server 104 also generally processes (including encoding and packetizing) each of its requested audio streams for transmission through the network access points 105 to the user devices 103 that made the access requests. In some embodiments, each server 104 does not process any of its audio streams that have not been requested by any user device 103. Additional functions and configurations of the servers 104 are described below with respect to FIGS. 19-21.

In some embodiments, each of the display devices 101 has a number, letter, symbol, code, thumbnail or other display indicator 107 associated with it. For example, the display indicator 107 for each display device 101 may be a sign mounted on or near the display device 101. The display indicator 107 generally uniquely identifies the associated display device 101. Additionally, either the servers 104 or the network access points 105 (or both) provide to the user devices 103 identifying information for each available audio stream in a manner that corresponds to the display indicators 107, as described below. Therefore, each user 102 is able to select through the user device 103 the audio stream that corresponds to the desired display device 101.

Particularly for, but not necessarily limited to, embodiments in which the environment 100 is a public venue or establishment (e.g., bar, pub, restaurant, airport lounge area, museum, medical waiting room, etc.), an information sign 108 may be provided within the environment 100 to present information to the users 102 regarding how to access the audio streams for the display devices 101 and any other features available through the application that they can run on their user devices 103. The information sign 108 may be prominently displayed within the environment 100. Alternatively, an information card with similar information may be placed on each of the tables within the environment 100, e.g., for embodiments involving a bar or restaurant.

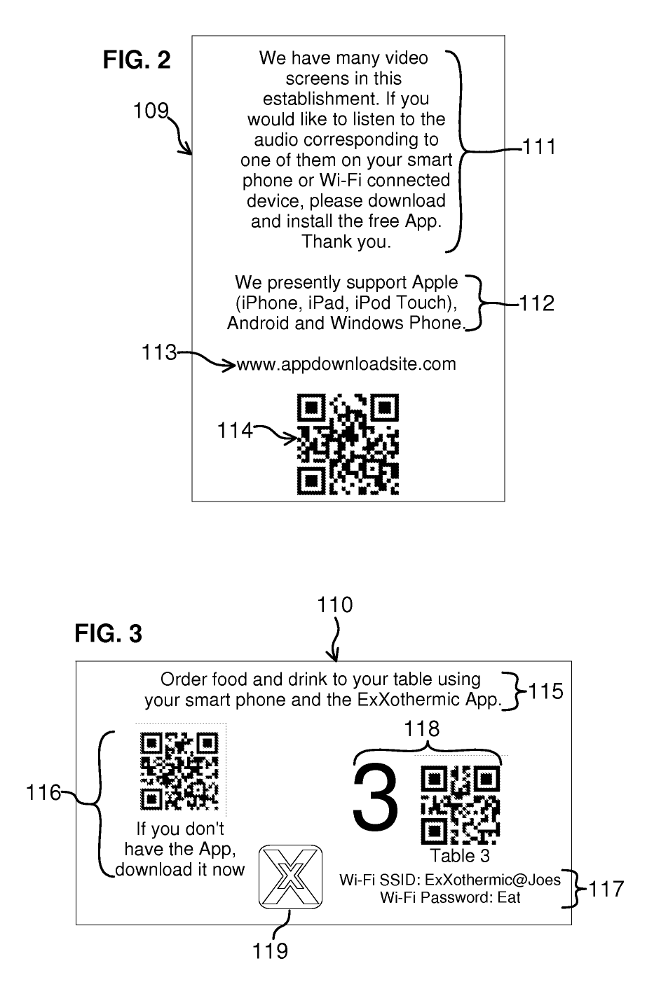

Two examples of an information sign (or card) that may be used for the information sign 108 are shown in FIGS. 2 and 3. The words shown on the example information sign/card 109 in FIG. 2 and the example information sign/card 110 in FIG. 3 are given for illustrative purposes only, so it is understood that embodiments of the present invention are not limited to the wordings shown. Any appropriate wording that provides any desired initial information is acceptable. Such information may include, but not be limited to, the availability of any of the functions described herein.

For the example information sign/card 109 in FIG. 2, a first section 111 generally informs the users 102 that they can listen to the audio for any of the display devices 101 by downloading an application to their smart phone or Wi-Fi enabled user device 103. A second example section 112 generally informs the users 102 of the operating systems or platforms or types of user devices 103 that the can use the application, e.g., Apple™ devices (iPhone™, iPad™ and iPod Touch™), Google Android™ devices or Windows Phone™ devices. (Other types of user devices may also be supported in other embodiments.) A third example section 113 generally provides a URL (uniform resource locator) that the users 102 may enter into their user devices 103 to download the application (or access a website where the application may be found) through a cell phone network or a network/wireless access point, depending on the capabilities of the user devices 103. The network access points 105 and servers 104, for example, may serve as a Wi-Fi hotspot through which the user devices 103 can download the application. A fourth example section 114 in the example information sign/card 109 generally provides a QR (Quick Response) Code™ (a type of matrix barcode or two-dimensional code for use with devices that have cameras, such as some types of the user devices 103) that can be used for URL redirection to acquire the application or access the website for the application.

The example information sign/card 110 in FIG. 3 generally informs the users 102 of the application and provides information for additional features available through the application besides audio listening. Such features may be a natural addition to the audio listening application, since once the users 102 have accessed the servers 104, this connection becomes a convenient means through which the users 102 could further interact with the environment 100. For example, in an embodiment in which the environment 100 is a bar or restaurant, a first section 115 of the example information sign/card 110 generally informs the users 102 that they can order food and drink through an application on their user device 103 without having to get the attention of a wait staff person. A second section 116 generally informs the users 102 how to acquire the application for their user devices 103. In the illustrated case, another QR Code is provided for this purpose, but other means for accessing a website or the application may also be provided.

A third section 117 generally provides a Wi-Fi SSID (Service Set Identifier) and password for the user 102 to use with the user device 103 to login to the server 104 through the network access point 105. The login may be done in order to download the application or after downloading the application to access the available services through the application. The application, for example, may recognize a special string of letters and/or numbers within the SSID to identify the network access point 105 as being a gateway to the relevant servers 104 and the desired services. (The SSIDs of the network access points 105 may, thus, be factory set in order to ensure proper interoperability with the applications on the user devices 103. Otherwise, instructions for an operator to set up the servers 104 and the network access points 105 in an environment 100 may instruct the operator to use a predetermined character string for at least part of the SSIDs.) In some embodiments, the application may be designed to ignore Wi-Fi hotspots that use SSIDs that do not have the special string of letters and/or numbers. In the illustrated case, an example trade name “ExXothermic” (used here and in other Figs.) is used as the special string of letters within the SSID to inform the application (or the user 102) that the network access point 105 with that SSID will lead to the appropriate server 104 and at least some of the desired services. In other embodiments, the SSIDs do not have any special string of letters or numbers, so the applications on the user devices 103 may have to query every accessible network access point 105 or hot spot to determine whether a server 104 is available. The remaining string “@Joes” is an example of additional optional characters in the SSID that may specifically identify the corresponding network access point 105 as being within a particular example environment 100 having an example name “Joe's”.

In an embodiment in which the example information sign/card 110 is associated with a particular table within the environment 100, a fourth section 118 generally identifies the table, e.g., with a letter, symbol or number (in this example, the number 3). An additional QR Code is also provided, so that properly equipped user devices 103 can scan the QR Code to identify the table. In this manner, the food and/or beverage order placed by the user 102 can be associated with the proper table for delivery by a wait staff person.

In addition to the example trade name “ExXothermic”, the example information sign/card 110 shows an example logo 119. With such pieces of information, the users 102 who have previously tried out the application on their user devices 103 at any participating environment 100 can quickly identify the current environment 100 as one in which they can use the same application.

In some embodiment, the servers 104 work only with “approved” applications. Such approval requirements may be implemented in a similar manner to that of set-top-boxes which are authorized to decode only certain cable or satellite channels. For instance, the servers 104 may encrypt the audio streams in a way that can be decrypted only by particular keys that are distributed only to the approved applications. These keys may be updated when new versions or upgrades of the application are downloaded and installed on the user devices 103. Alternatively, the application could use other keys to request the servers 104 to send the keys for decrypting the audio streams.

Similarly, in some embodiments, the applications may work only with “approved” servers 104. For example, the application may enable audio streaming only after ascertaining, through an exchange of keys, that the transmitting server 104 is approved.

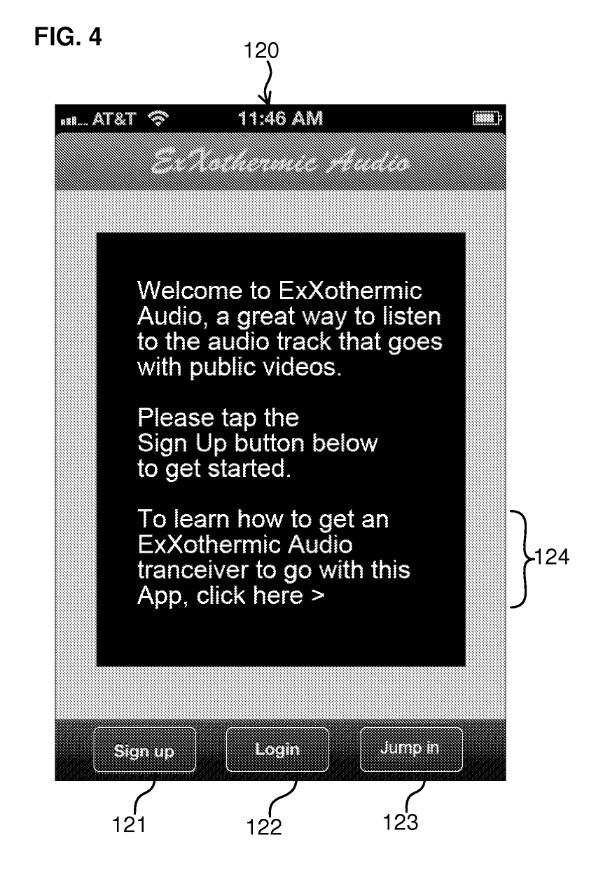

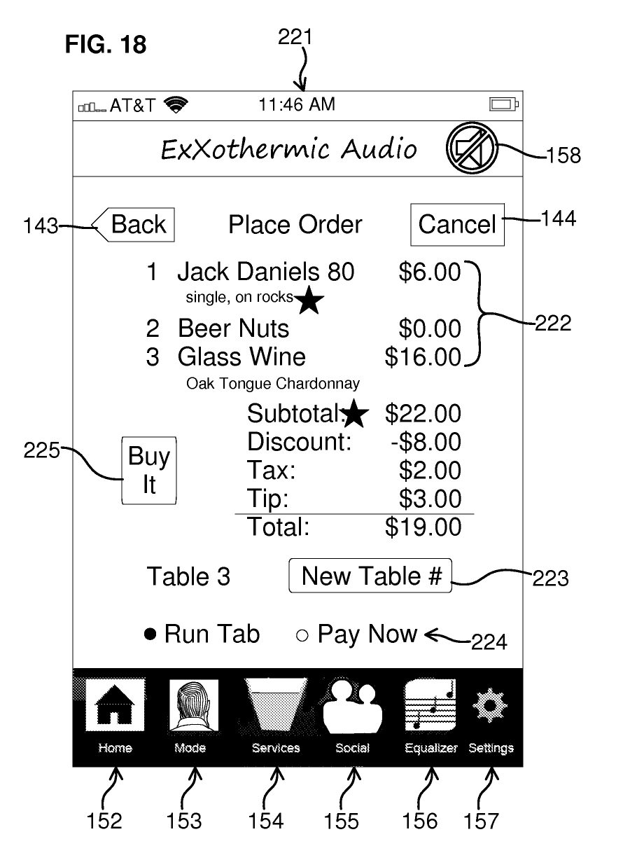

The downloading of the application to the user devices 103 is generally performed according to the conventional functions of the user devices 103 and does not need to be described here. Once downloaded, the exact series of information or screens presented to the users 102 through the user devices 103 may depend on the design choices of the makers of the application. For an embodiment using a smart phone or other multifunctional mobile device for the user device 103, an example series of views or simulated screenshots of screens of a user interface for the application is provided in FIGS. 4-18. It is understood, however, that the present invention is not necessarily limited to these particular examples. Instead, these examples are provided for illustrative purposes only, and other embodiments may present any other appropriate information, options or screen views, including, but not limited to, any that may be associated with any of the functions described herein. Additionally, any of the features shown for any of the screens in FIGS. 4-18 may be optional where appropriate.

In the illustrated example, an initial welcome screen 120, as shown in FIG. 4, is presented on a display of the user devices 103 to the users 102 upon launching the application on their user devices 103. Additionally, an option is provided to the users 102 to “sign up” (e.g., a touch screen button 121) for the services provided by the application, so the servers 104 can potentially keep track of the activities and preferences of the users 102. If already signed up, the users 102 may “login” (e.g., a touch screen button 122) to the services. Alternatively, the users 102 may simply “jump in” (e.g., a touch screen button 123) to the services anonymously for those users 102 who prefer not to be tracked by the servers 104. Furthermore, an example touch screen section 124 may lead the users 102 to further information on how to acquire such services for their own environments 100. Other embodiments may present other information or options in an initial welcome screen.

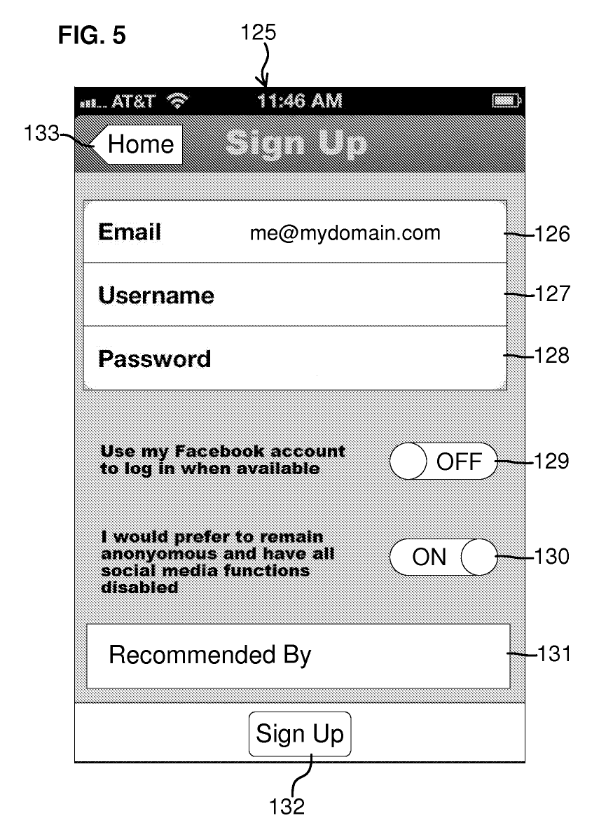

In this example, if the user 102 chooses to “sign up” (button 121, FIG. 4), then the user 102 is directed to a sign up screen 125, as shown in FIG. 5. The user 102 may then enter pertinent information, such as an email address, a username and a password in appropriate entry boxes, e.g., 126, 127 and 128, respectively. The user 102 may also be allowed to link (e.g., at 129) this sign up with an available social networking service, such as Internet-based social networking features of Facebook (as shown), Twitter, Google+ or the like (e.g., for ease of logging in or to allow the application or server 104 to post messages on the user's behalf within the social networking site). Additionally, the user 102 may be allowed to choose (e.g., at 130) to remain anonymous (e.g., to prevent being tracked by the server 104) or to disable social media/networking functions (e.g., to prevent the application or server 104 from posting messages on the user's behalf to any social networking sites). However, by logging in (not anonymously) when they enter an environment 100, the users 102 may garner “loyalty points” for the time and money they spend within the environments 100. The application and/or the servers 104 may track such time and/or money for each user 102 who does not login anonymously. Thus, the users 102 may be rewarded with specials, discounts and/or free items by the owner of the environment 100 or by the operator of the servers 104 when they garner a certain number of “loyalty points.”

Furthermore, an optional entry box 131 may be provided for a new user 102 to enter identifying information of a preexisting user 102 who has recommended the application or the environment 100 to the new user 102. In this manner, the new user 102 may be linked to the preexisting user 102, so that the server 104 or the owners of the environment 100 may provide bonuses to the preexisting user 102 for having brought in the new user 102. The users 102 may also garner additional “loyalty points” for bringing in new users 102 or simply new customers to the environment 100. The users 102 may gain further loyalty points when the new users 102 return to the environment 100 in the future.

After entering all of the pertinent information and selecting the various options, the user 102 may press a touch screen button 132 to complete the sign up. Alternatively, the user 102 may prefer to return to the initial welcome screen 120 by pressing another touch screen button 133 (e.g., “Home”). Other embodiments may offer other sign up procedures or selections.

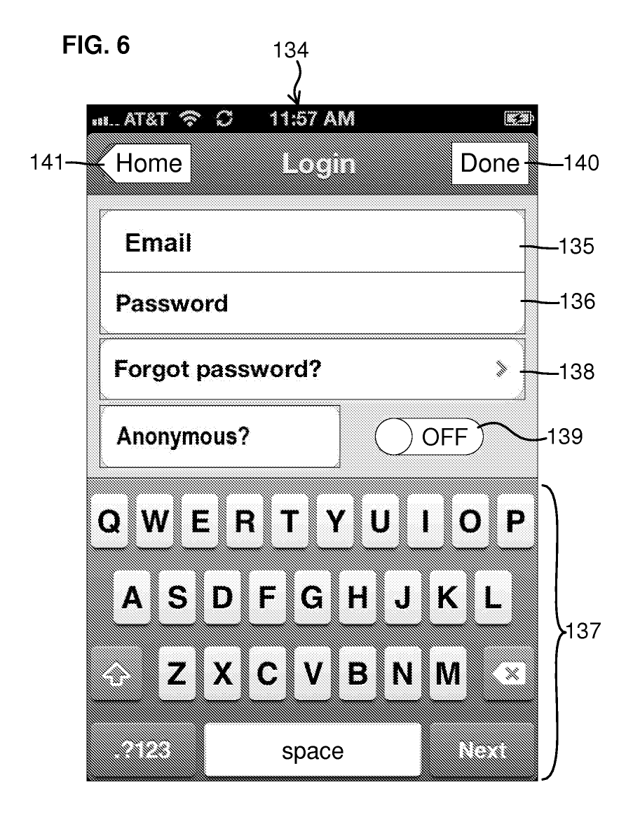

In this example, if the user 102 chooses to “login” (button 122, FIG. 4), then the user 102 is directed to a login screen 134, as shown in FIG. 6. The user 102 thus enters an email address (e.g., at 135) and password (e.g., at 136) using a touch screen keyboard (e.g., at 137). There is also an option (e.g., at 138) for the user 102 to select when the user 102 has forgotten the password. Furthermore, there is another option for the user 102 to set (e.g., at 139) to always login anonymously or not. There is a touch screen button “Done” 140 for when the user 102 has finished entering information or making selections. Additionally, there is a touch screen button “Home” 141 for the user 102 to return to the initial welcome screen 120 if desired. Other embodiments may offer other login procedures or selections.

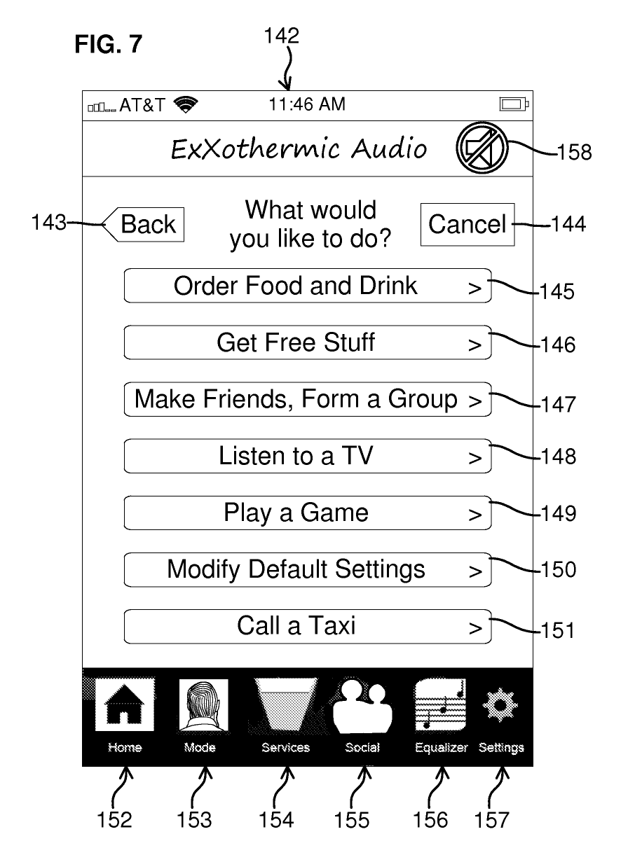

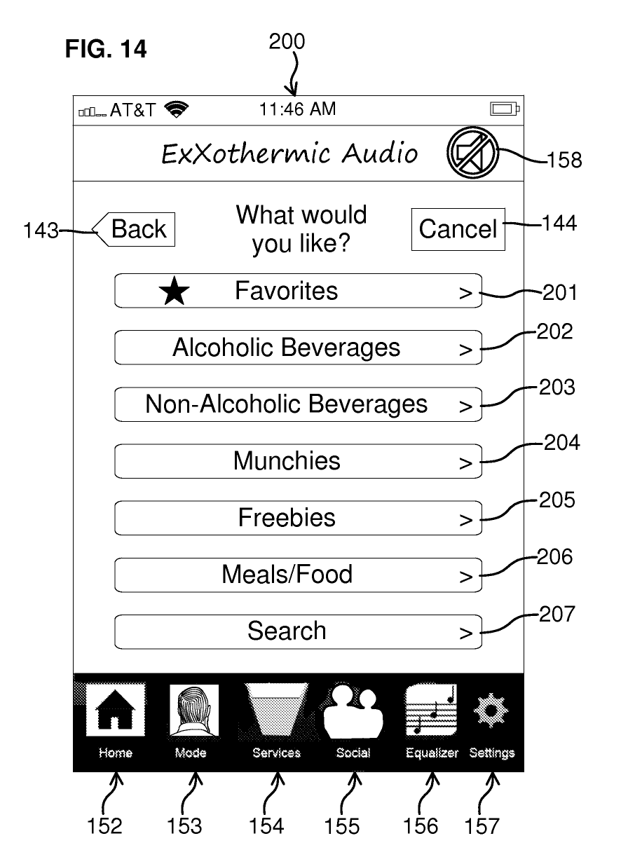

In this example, after the user 102 has signed up or logged in, the user device 103 presents a general action selection screen 142, as shown in FIG. 7, wherein the user 102 is prompted for an action by asking “What would you like to do?” “Back” (at 143) and “Cancel” (at 144) touch screen buttons are provided for the user 102 to return to an earlier screen, cancel a command or exit the application if desired. An option to order food and drinks (e.g., touch screen button 145) may lead the user 102 to another screen for that purpose, as described below with respect to FIGS. 14-18. An option (e.g., touch screen button 146) may be provided for the user 102 to try to obtain free promotional items being given away by an owner of the environment 100. Touching this button 146, thus, may present the user 102 with another screen (not shown) for such opportunities.

An option (e.g., touch screen button 147) to make friends, meet other people and/or potentially join or form a group of people within the environment 100 may lead the user 102 to yet another screen (not shown). Since it is fairly well established that customers of a bar or pub, for example, will have more fun if they are interacting with other customers in the establishment, thereby staying to buy more products from the establishment, this option may lead to any number or combinations of opportunities for social interaction by the users 102. Any type of environment 100 may, thus, reward the formation of groups of the users 102 by providing free snacks, munchies, hors d′oeuvres, appetizers, drinks, paraphernalia, goods, services, coupons, etc. to members of the group. The users 102 also may come together into groups for reasons other than to receive free stuff, such as to play a game or engage in competitions or just to socialize and get to know each other. The application on the user devices 103, thus, may facilitate the games, competitions and socializing by providing a user interface for performing these tasks. Various embodiments, therefore, may provide a variety of different screens (not shown) for establishing and participating in groups or meeting other people or playing games within the environment 100. Additionally, such activities may be linked to the users' social networks to enable further opportunities for social interaction. In an embodiment in which the environment 100 is a workout gym, for example, a user 102 may use the form-a-group button 147 to expedite finding a workout partner, e.g., someone who generally shows up around the same time as the user 102. A user 102 could provide a relationship status to other users 102 within the gym, e.g., “always works alone”, “looking for a partner”, “need a carpool”, etc.

The formation of the groups may be done in many different ways. For example, the application may lead some users 102 to other users 102, or some users 102 may approach other customers (whether they are other users 102 or not) within the environment 100, or some users 102 may bring other people into the environment, etc. To establish multiple users 102 as a group, the users 102 may exchange some identifying information that they enter into the application on their user devices 103, thereby linking their user devices 103 into a group. In order to prevent unwanted exchange of private information, for example, the server 104 or the application on the user devices 103 may randomly generate a code that one user 102 may give to another user 102 to form a group. Alternatively, the application of one user device 103 may present a screen with another QR Code of which another user device 103 (if so equipped) may take a picture in order to have the application of the other user device 103 automatically link the user devices 103 into a group. Other embodiments may use other appropriate ways to form groups or allow users 102 to meet each other within environments 100.

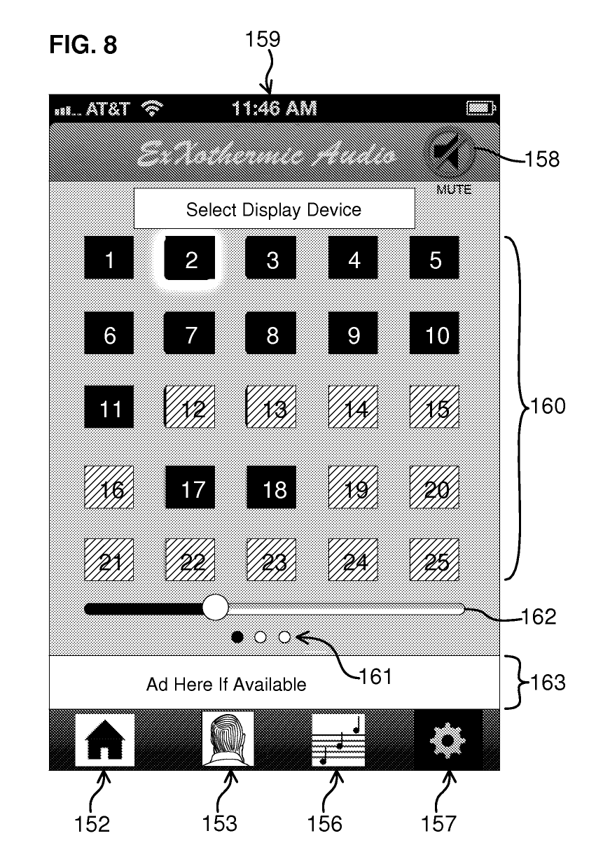

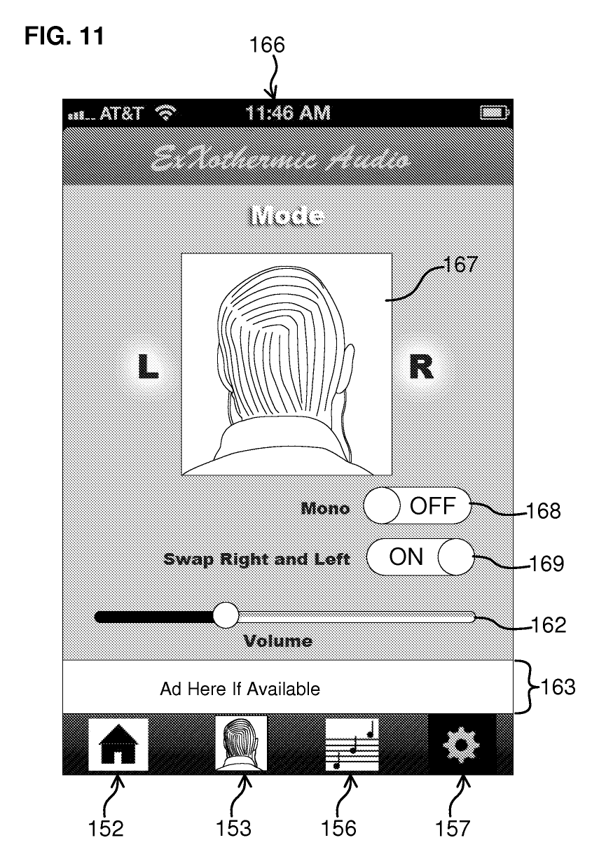

An option to listen to one of the display devices 101 (e.g., “listen to a TV” touch screen button 148) may lead the user 102 to another screen, such as is described below with reference to FIG. 8. Another option (e.g., touch screen button 149) to play a game (e.g., a trivia game, and with or without a group) may lead the user 102 to one or more additional screens (not shown). Another option (e.g., touch screen button 150) to modify certain settings for the application may lead the user 102 to one or more other screens, such as those described below with reference to FIGS. 11-13. Furthermore, another option (e.g., touch screen button 151) to call a taxi may automatically place a call to a taxi service or may lead the user 102 to another screen (not shown) with further options to select one of multiple known taxi services that operate near the environment 100.

Other embodiments may include other options for general functions not shown in FIG. 7. For example, for an embodiment in which the environment 100 is an exercise gym or facility, the application may provide an option for the user 102 to keep track of exercises and workouts and time spent in the gym. In another example, for an embodiment in which the environment 100 is a bar, the application may provide an option for the user 102 to keep track of the amount of alcohol the user 102 has consumed over a period of time. The alcohol consumption data may also be provided to the server 104 in order to alert a manager or wait staff person within the environment 100 that a particular user 102 may need a free coffee or taxi ride.

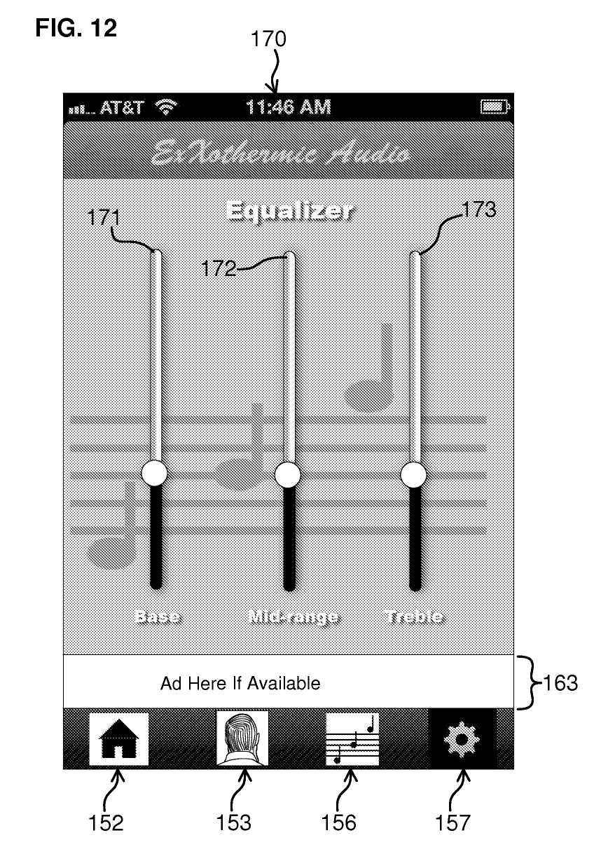

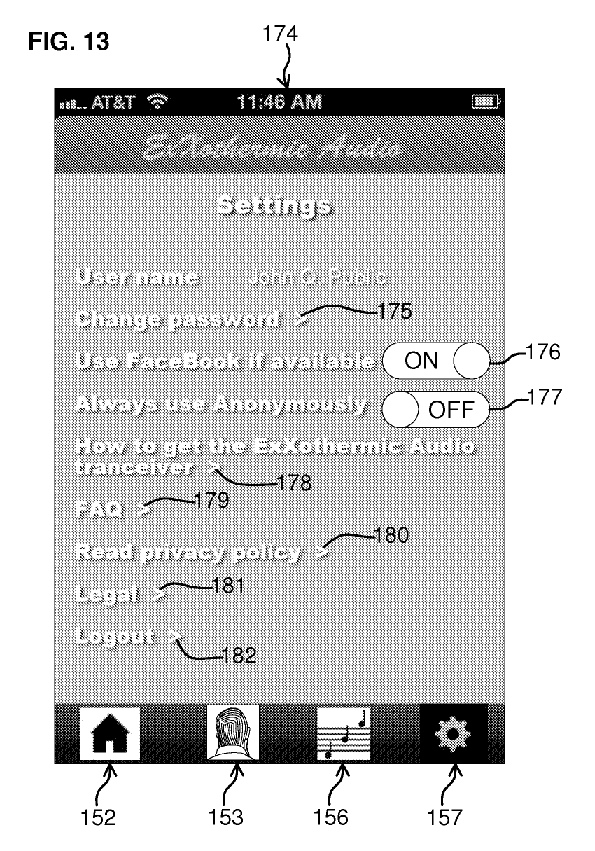

In addition to the other options described herein, a set of icon control buttons 152-157 that may be used on multiple screens are shown at the bottom of the general action selection screen 142. For example, a home icon 152 may be pressed to take the user 102 back to an initial home screen, such as the initial welcome screen 120 or the general action selection screen 142. A mode icon 153 may be pressed to take the user 102 to a mode selection screen, such as that described below with respect to FIG. 11. A services icon 154, similar to the function of the “order food and drinks” touch screen button 145 described above, may be pressed to take the user 102 to a food and drink selection screen, as described below with respect to FIGS. 14-18. A social icon 155, similar to the “make friends or form a group” touch screen button 147 described above, may be pressed for a similar function. An equalizer icon 156 may be pressed to take the user 102 to an equalizer selection screen, such as that described below with respect to FIG. 12. A settings icon 157 may be pressed to take the user 102 to a settings selection screen, such as that described below with respect to FIG. 13. Other embodiments may use different types or numbers (including zero) of icons for different purposes.

Furthermore, the general action selection screen 142 has a mute icon 158. If the application is playing an audio stream associated with one of the display devices 101 (FIG. 1) while the user 102 is viewing this screen 142, the user 102 has the option of muting (and un-muting) the audio stream by pressing the mute icon 158. In some embodiments in which the user device 103 is a smart phone, the mute function may be automatic when a call comes in. On the other hand, in an embodiment in which the environment 100 is a movie theater and the user device 103 is a smart phone, the application on the user device 103 may automatically silence the ringer of the user device 103.

In this example, after the user 102 has signed up, logged in or made an appropriate selection (such as pressing the “listen to a TV” touch screen button 148, mentioned above), the application on the user device 103 presents a display device selection screen 159, as shown in FIG. 8. This selection screen 159 prompts the user 102 to select one of the display devices 101 for listening to the associated audio stream. Thus, the display device selection screen 159 presents a set or table of display identifiers 160.

The display identifiers 160 generally correspond to the numbers, letters, symbols, codes, thumbnails or other display indicators 107 associated with the display devices 101, as described above. In the illustrated example, the numbers 1-25 are displayed. The numbers 1-11, 17 and 18 are shown as white numbers on a black background to indicate that the audio streams for the corresponding display devices 101 are available to the user device 103. The numbers 12-16 and 19-25 are shown as black numbers on a cross-hatched background to indicate that either there are no display devices 101 that correspond to these numbers within the environment 100 or the network access points 105 that service these display devices 101 are out of range of the user device 103. The user 102 may select any of the available audio streams by pressing on the corresponding number. The application then connects to the network access point 105 that services or hosts the selected audio stream. The number “2” is highlighted to indicate that the user device 103 is currently accessing the display device 101 that corresponds to the display indicator 107 number “2”.

In some embodiments, the servers 104 may provide audio streams not associated with any of the display devices 101. Examples may include Pandora™ or Sirius™ radio. Therefore, additional audio identifiers or descriptors (not shown) may be presented alongside the display identifiers 160.

The application on the user device 103 may receive or gather data that indicates which display identifiers 160 should be presented as being available in a variety of different ways. For example, the SSIDs for the network access points 105 may indicate which display devices 101 each network access point 105 services. In some embodiments, if the network access points 105 each service only one display device 101, then the display indicator 107 (e.g., a number or letter) may be part of the SSID and may follow immediately after a specific string of characters. For example, if the application on the user device 103 receives an SSID of “ExX12” from a network access point 105, the application may interpret the string “ExX” as indicating that the network access point 105 is connected to at least one of the desired servers 104 and that the audio stream corresponding to the display device 101 having the display indicator 107 of number “12” is available. In other embodiments, if the network access points 105 service more than one display device 101, but each display indicator 107 is guaranteed to be only a single character, then an SSID of “ExX034a” may indicate that the network access point 105 services the display devices 101 that have the display indicators 107 of numbers “0”, “3” and “4” and letter “a”. In another embodiment, if the network access points 105 service more than one display device 101, and each display indicator 107 is guaranteed to be no bigger than three characters, then an SSID of “ExX005007023” may indicate that the network access point 105 services the display devices 101 that have the display indicators 107 of numbers “5”, “7” and “23”. In another embodiment, an SSID of “ExX#[5:8]” may indicate that the network access point 105 services the display devices 101 that have the display indicators 107 of numbers “5”, “6”, “7” and “8”.

In some embodiments, however, the SSIDs do not indicate which display devices 101 each network access point 105 services. In such cases, the application on the user devices 103 may have to login to each accessible network access point 105 and query each connected server 104 for a list of the available display indicators 107. Each of the network access points 105 may potentially have the same recognizable SSID in this case. Other embodiments may user other techniques or any combination of these and other techniques for the applications on the user devices 103 to determine which display identifiers 160 are to be presented as available. If the operating system of the user device 103 does not allow applications to automatically select an SSID to connect to a network access point 105, then the application may have to present available SSIDs to the user 102 for the user 102 to make the selection.

A set of page indicator circles 161 are also provided. The number of page indicator circles 161 corresponds to the number of pages of display identifiers 160 that are available. In the illustrated example, three page indicator circles 161 are shown to indicate that there are three pages of display identifiers 160 available. The first (left-most) page indicator circle 161 is fully blackened to indicate that the current page of display identifiers 160 is the first such page. The user 102 may switch to the other pages by swiping the screen left or right as if leafing through pages of a book. Other embodiments may use other methods of presenting multiple display identifiers 160 or multiple pages of such display identifiers 160.

Additionally, other embodiments may allow other methods of selecting an audio stream. For example, If the user device 103 contains a camera, the channel selection can be done by a bar code or QR Code on the information sign 108 (FIG. 1) or with the appropriate pattern recognition software by pointing the camera at the desired display device 101 or at a thumbnail of the show that is playing on the display devices 101. There may also be other designators which may include electromagnetic signatures.

Alternatively, the application may switch to a different audio stream based on whether the user points the camera of the user device 103 at a particular display device 101. Also, low-resolution versions of the available video streams could be transmitted to the user device 103, so the application can correlate the images streamed to the user device 193 and the image seen by the camera of the user device 103 to choose the best display device 101 match. Alternatively, the image taken by the camera of the user device 103 may be transmitted to the server 104 for the server 104 to make the match.

In other embodiments, a motion/direction sensor, e.g., connected to the user's listening device, may determine which direction the user 102 is looking, so that when the user 102 looks in the direction of a particular display device 101, the user 102 hears the audio stream for that display device 101. Additionally or in the alternative, when the user 102 looks at a person, a microphone turns on, so the user may hear that person. A locking option may allow the user 102 to prevent the application from changing the audio stream every time the user 102 looks in a different direction. In some embodiments, the user 102 may toggle a touch screen button when looking at a particular display device 101 in order to lock onto that display device 101. In some embodiments, the application may respond to keying sequences so that the user 102 can quickly select a mode in which the user device 103 relays an audio stream. For example, a single click of a key may cause the user device 103 to pause the sound. Two clicks may be used to change to a different display device 101. The user 102 may, in some embodiments, hold down a key on the user device 103 to be able to scan various audio streams, for example, as the user 102 looks in different directions, or as in a manner similar to the scan function of a car radio.

In this example, a volume slider bar 162 is provided to enable the user 102 to control the volume of the audio stream. Alternatively, the user 102 could adjust the volume using a volume control means built in to the user device 103. Additionally, the mute icon 158 is provided in this screen 159 to allow the user 102 to mute and un-mute the audio stream.

In this example, some of the icon control buttons 152-157 shown in FIG. 7 and described above are also shown in FIG. 8. For the screen 159, however, only the icon buttons 152, 153, 156 and 157 are shown to illustrate the option of using only those icon control buttons that may be relevant to a particular screen, rather than always using all of the same icon control buttons for every screen.

Furthermore, the screen 159 includes an ad section 163. A banner ad or scrolling ad or other visual message may be placed here if available. For example, the owner of the environment 100 or the operator of the servers 104 or other contractors may insert such ads or messages into this screen 159 and any other appropriate screens that may be used. Additionally, such visual ads or messages or coupons may be provided to the users 102 via pop-up windows or full screens.

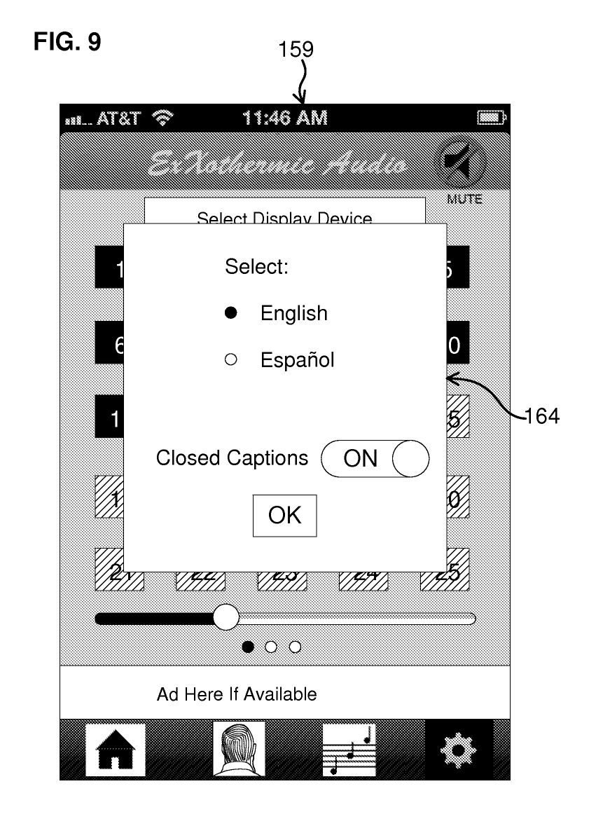

In this example, upon selecting one of the display identifiers 160 in the display device selection screen 159, an additional selection screen may be presented, such as a pop-up window 164 that may appear over the screen 159, as shown in FIG. 9. Some of the video streams that may be provided to the display devices 101, for example, may have more than one audio stream available, i.e., may support an SAP (Second Audio Program). The pop-up window 164, therefore, illustrates an example in which the user 102 may select an English or Spanish (Espanol) audio stream for the corresponding video stream. Additionally, closed captioning or subtitles may be available for the video stream, so the user 102 may turn on this option in addition to or instead of the selected audio stream. The user 102 may then read the closed captions more easily with the user device 103 than on the display device 102, since the user 102 may have the option of making the text as large as necessary to read comfortably. Additionally, in some embodiments, the servers 104 or applications on the user devices 103 may provide real time language translation to the user 102, which may be an option that the user 102 may select on the pop-up window 164. This feature could be stand-alone or connected via the Internet to cloud services such as Google Translate™.

After selecting a desired audio stream and/or closed captioning as in FIG. 8 and/or 9, the application may present any appropriate screen while the user 102 listens to the audio stream (or reads the closed captions). For example, the application may continue to present the display device selection screen 159 of FIG. 8 or return to the general action selection screen 142 of FIG. 7 or simply blank-out the screen during this time. For closed captions, a special closed captioning screen (not shown) may be presented. For embodiments in which the environment 100 is a home or movie theater, for example, it may be preferable to ensure that the screen of the user device 103 does not put out too much light that might annoy other people in the home or movie theater. The special closed captioning screen, for example, may use light colored or red letters on a dark background, to minimize the output of light. In some embodiments, the screen on the user device 103 could show any data feed that the user 102 desires, such as a stock ticker.

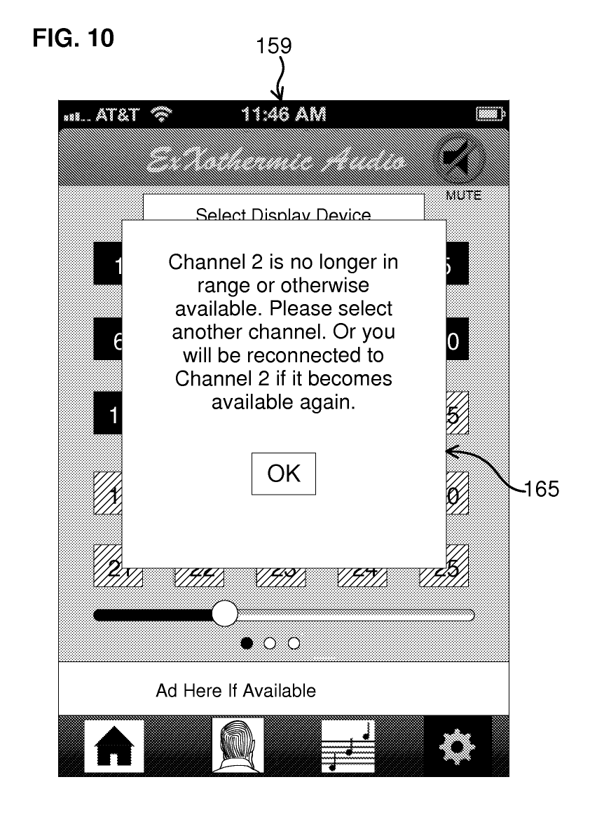

While the user 102 is listening to the audio stream, the user 102 may move around within the environment 100 or even temporarily leave the environment 100. In doing so, the user 102 may go out of range of the network access point 105 that is supplying the audio stream. For example, the user 102 may go to the restroom in the environment 100 or go outside the environment 100 to smoke or to retrieve something from the user's car and then return to the user's previous location within the environment 100. In this case, while the user device 103 is out of range of the network access point 105 intended to serve the desired audio stream, the corresponding server 104 may route the audio stream through another server 104 to another network access point 105 that is within range of the user device 103, so that the user device 103 may continue to receive the audio stream relatively uninterrupted. Alternatively, the application may present another screen to inform the user 102 of what has happened. For example, another pop-up window 165 may appear over the screen 159, as shown in FIG. 10. In this example, the pop-up window 165 generally informs the user 102 that the network access point 105 is out of range or that the audio stream is otherwise no longer available. Optionally, the application may inform the user 102 that it will reconnect to the network access point 105 and resume playing the audio stream if it becomes available again. Additionally, the application may prompt the user 102 to select a different audio stream if one is available. In some embodiments, the application may drop into a power save mode until the user 102 selects an available display identifier 160.

In some embodiments, more than one of the network access points 105 may provide the same audio stream or service the same display device 101. Alternatively, the servers 104 may keep track of which of the display devices 101 are presenting the same video stream, so that the corresponding audio streams, which may be serviced by different network access points 105, are also the same. In either case, multiple network access points 105 located throughout the environment 100 may be able to transmit the same audio streams. Therefore, some embodiments may allow for the user devices 103 to switch to other network access points 105 as the user 102 moves through the environment 100 (or relatively close outside the environment 100) in order to maintain the selected audio stream. The SSIDs of more than one network access point 105 may be the same to facilitate such roaming. This feature may superficially resemble the function of cell phone systems that allow cell phones to move from one cell transceiver to another without dropping a call.

In some embodiments, the application on the user device 103 may run in the background, so the user 102 can launch a second application on the user device 103. However, if the second application logs into an SSID not associated with the network access points 105 or servers 104 for the audio streaming, then the audio streaming may be disabled. In this case, another screen or pop-up window (not shown) may be used to alert the user 102 of this occurrence. However, if the user device 103 has already lost contact with the network access point 105 (e.g., the user 102 has walked out of range), then the application may allow the changing of the SSID without interference.

An example mode selection screen 166 for setting a mode of listening to the audio stream is shown in FIG. 11. The application on the user device 103 may present this or a similar screen when the user 102 presses the mode icon 153, mentioned above. In this example, an enlarged image 167 of the mode icon 153 (e.g., an image or drawing of the back of a person's head with wired earbuds attached to the person's ears) is shown in about the middle of the screen 166. The letters “L” and “R” indicate the left and right earbuds or individual audio streams. A touch switch 168 is provided for selecting a mono, rather than a stereo, audio stream if desired. Another touch switch 169 is provided for switching the left and right individual audio streams if desired. Additionally, the volume slider bar 162, the ad section 163 and some of the icon buttons 152, 153, 156 and 157 are provided. Other embodiments may provide other listening mode features for selection or adjustment or other means for making such selections and adjustments. In still other embodiments, the application does not provide for any such selections or adjustments.

An example equalizer selection screen 170 for setting volume levels for different frequencies of the audio stream is shown in FIG. 12. The application on the user device 103 may present this or a similar screen when the user 102 presses the equalizer icon 156, mentioned above. In this example, slider bars 171, 172 and 173 are provided for adjusting base, mid-range and treble frequencies, respectively. Additionally, the ad section 163 and some of the icon buttons 152, 153, 156 and 157 are provided. Other embodiments may provide other equalizer features for selection or adjustment or other means for making such selections and adjustments. In still other embodiments, the application does not provide for any such selections or adjustments.

An example settings selection screen 174 for setting various preferences for, or obtaining various information about, the application is shown in FIG. 13. The application on the user device 103 may present this or a similar screen when the user 102 presses the settings icon 157, mentioned above. In this example, the username of the user 102 is “John Q. Public.” An option 175 is provided for changing the user's password. An option 176 is provided for turning on/off the use of social networking features (e.g., Facebook is shown). An option 177 for turning on/off a setting to login anonymously. An option 178 is provided that may lead the users 102 to further information on how to acquire such services for their own environments 100. An option 179 is provided that may lead the users 102 to a FAQ (answers to Frequently Asked Questions) regarding the available services. An option 180 is provided that may lead the users 102 to a text of the privacy policy of the owners of the environment 100 or operators of the servers 104 regarding the services. An option 181 is provided that may lead the users 102 to a text of a legal policy or disclaimer with regard to the services. Additionally, an option 182 is provided for the users 102 to logout of the services. Other embodiments may provide for other application settings or information.

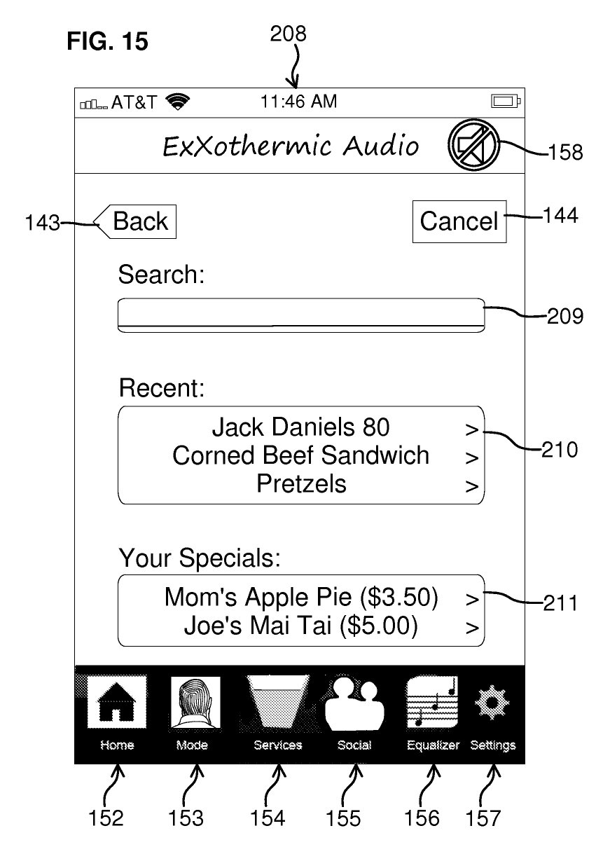

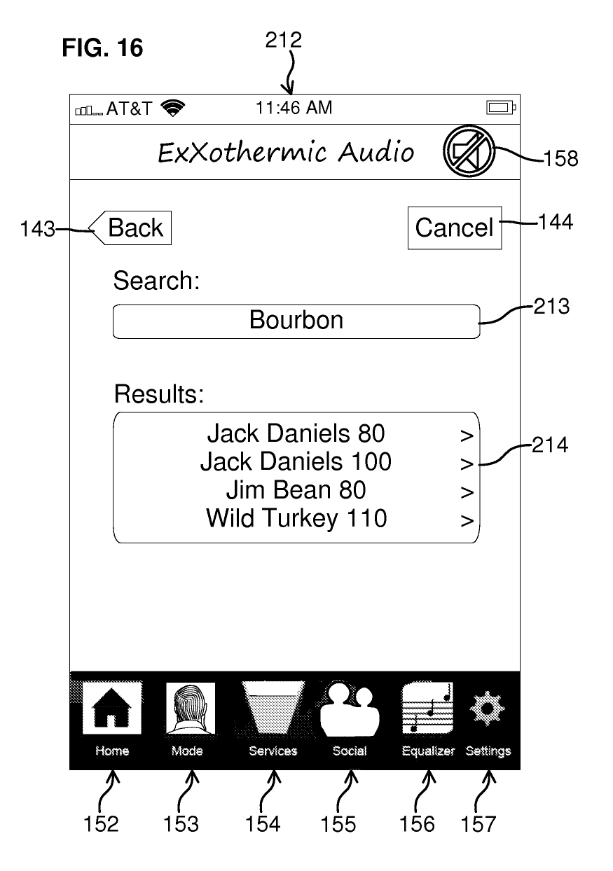

For embodiments in which the environment 100 is a bar or restaurant type of establishment, an initial food and drinks ordering screen 200 for using the application to order food and drinks from the establishment is shown in FIG. 14. The application on the user device 103 may present this or a similar screen when the user 102 presses the “order food and drinks” touch screen button 145 or the services icon 154, mentioned above. In this example, a “favorites” option 201 is provided for the user 102 to be taken to a list of items that the user 102 has previously or most frequently ordered from the current environment 100 or that the user 102 has otherwise previously indicated are the user's favorite items. A star icon is used to readily distinguish “favorites” in this and other screens. An “alcoholic beverages” option 202 is provided for the user 102 to be taken to a list of available alcoholic beverages. Information provided by the user 102 in other screens (not shown) or through social networking services may help to confirm whether the user 102 is of the legal drinking age. A “non-alcoholic beverages” option 203 is provided for the user 102 to be taken to a list of available non-alcoholic beverages, such as sodas, juices, milk, water, etc. A “munchies” option 204 is provided for the user 102 to be taken to a list of available snacks, hors d′oeuvres, appetizers or the like. A “freebies” option 205 is provided for the user 102 to be taken to a list of free items that the user 102 may have qualified for with “loyalty points” (mentioned above), specials or other giveaways. A “meals/food” option 206 is provided for the user 102 to be taken to a list of available food menu items. A “search” option 207 is provided for the user 102 to be taken to a search screen, as described below with reference to FIGS. 15 and 16. Additionally, the “Back” (at 143) and “Cancel” (at 144) touch screen buttons, the mute icon 158 and the icon control buttons 152-157 are also provided (mentioned above). Other embodiments may provide for other options that are appropriate for an environment 100 in which food and drink type items are served.

In this example, if the user 102 selects the “search” option 207, then the user 102 may be presented with a search screen 208, as shown in FIG. 15. Tapping on a search space 209 may cause another touch screen keyboard (e.g., as in FIG. 6 at 137) to appear below the search space 209, so the user 102 can enter a search term. Alternatively, the user 102 may be presented with a section 210 showing some of the user's recently ordered items and a section 211 showing some specials available for the user 102, in case any of these items are the one that the user 102 intended to search for. The user 102 could then bypass the search by selecting one or more of these items in section 210 or 211. Additionally, the “Back” (at 143) and “Cancel” (at 144) touch screen buttons, the mute icon 158 and the icon control buttons 152-157 are also provided (mentioned above). Other embodiments may present other search options that may be appropriate for the type of environment 100.

In this example, if the user 102 enters a search term in the search screen 208, then the user 102 may be presented with a results screen 212, as shown in FIG. 16. In this case, the search term entered by the user 102 is shown in another search space 213, and search results related to the search term are shown in a results space 214. The user 102 may then select one of these items by pressing on it or return to the previous screen to do another search (e.g., pressing the “back” touch screen button 143) or cancel the search and return to the initial food and drinks ordering screen 200 or the general action selection screen 142 (e.g., pressing the “cancel” touch screen button 144). Additionally, the mute icon 158 and the icon control buttons 152-157 are also provided (mentioned above). Other embodiments may present other results options that may be appropriate for the type of environment 100.

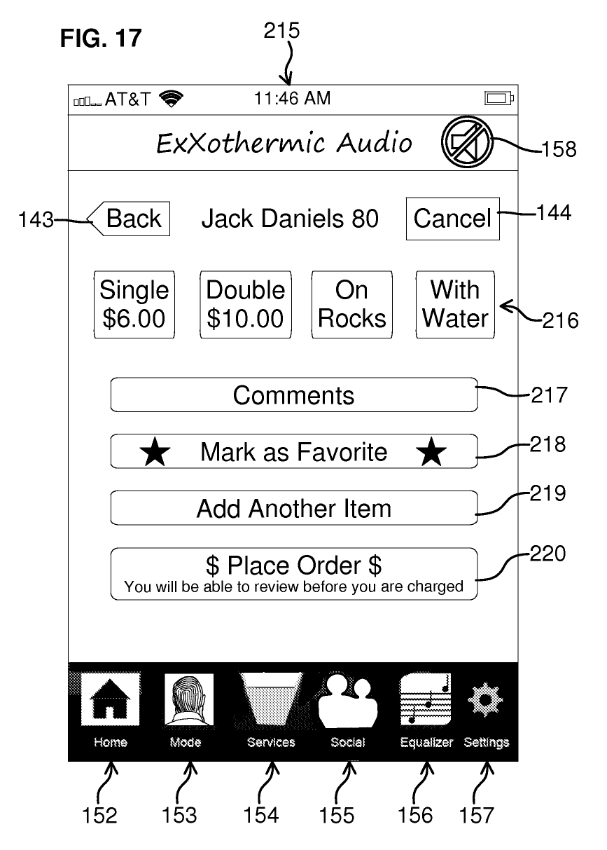

In this example, if the user 102 selects an item to purchase, either from the search or results screens 208 or 212 or from any of the screens to which the user 102 was directed by any of the options 201-206 on the initial food and drinks ordering screen 200, then the user 102 may be presented with an item purchase screen 215, as shown in FIG. 17. A set of order customization options 216 may be provided for the user 102 to make certain common customizations of the order. Alternatively, a “comments” option 217 may be provided for the user 102 to enter any comments or special instructions related to the order. Another option 218 may be provided for the user 102 to mark this item as one of the user's favorites, which may then show up when the user 102 selects the “favorites” option 201 on the initial food and drinks ordering screen 200 in the future. Another option 219 may be provided for the user 102 to add another item to this order, the selection of which may cause the user 102 to be returned to the initial food and drinks ordering screen 200. A “place order” option 220 may be provided for the user 102 to go to another screen on which the user 102 may review the entire order, as well as make selections to be changed for the order. Additionally, the “Back” (at 143) and “Cancel” (at 144) touch screen buttons, the mute icon 158 and the icon control buttons 152-157 are also provided (mentioned above). Other embodiments may present other options for allowing the user 102 to customize the selected item as may be appropriate.

In this example, if the user 102 chooses to purchase any items through the application on the user device 103, e.g., by pressing the “place order” option 220 on screen 215, the user 102 may be presented with a screen 221 with which to place or confirm the order. In this example, the user 102 has selected three items 222 to purchase, one of which is free since it is perhaps a freebie provided to all customers or perhaps the user 102 has earned it with loyalty points (mentioned above). The user 102 may change any of the items 222 by pressing the item on the screen 221. Favorite items may be marked with the star, and there may be a star touch screen button to enable the user to select all of the items 222 as favorites. Any other discounts the user 102 may have due to loyalty points or coupons may be shown along with a subtotal, tax, tip and total. The tip percentage may be automatically set by the user 102 within the application or by the owners/operators of the environment 100 through the servers 104. The user's table identifier (e.g., for embodiments with tables in the environment 100) is also shown along with an option 223 to change the table identifier (e.g., in case the user 102 moves to a different table in the environment 100). Selectable options 224 to either run a tab or to pay for the order now may be provided for the user's choice. The order may be placed through one of the servers 104 when the user 102 presses a “buy it” touch screen button 225. The order may then be directed to a user device 103 operated or carried by a manager, bartender or wait staff person within the environment 100 in order to fill the order and to present the user 102 with a check/invoice when necessary. In some embodiments, payment may be made through the application on the user device 103 to the servers 104, so the wait staff person does not have to handle that part of the transaction. Additionally, the “Back” (at 143) and “Cancel” (at 144) touch screen buttons, the mute icon 158 and the icon control buttons 152-157 are also provided (mentioned above). Other embodiments may present other options for allowing the user 102 to complete, confirm or place the order as may be appropriate.

An example architecture for connecting at least some of the A/V equipment within the environment 100 is shown in FIG. 19 in accordance with an embodiment of the present invention. (Other embodiments in which the functions of the server 104 are not within the environment 100 are described elsewhere.) The A/V equipment generally includes one or more A/V sources 226, one or more optional receiver (and channel selector) boxes or A/V stream splitters (the optional receiver) 227, one or more of the display devices 101, one or more of the servers 104 and one or more wireless access points (WAPs) 228 (e.g., the network access points 105 of FIG. 1). It is understood, however, that the present invention is not necessarily limited to the architecture shown. Additionally, some variations on the illustrated architecture may render some of the components or connections unnecessary or optional.

The A/V sources 226 may be any available or appropriate A/V stream source. For example, the A/V sources 226 may be any combination of cable TV, TV antennas, over-the-air TV broadcasts, satellite dishes, VCR/DVD/Blue-ray/DVR devices or network devices (e.g., for Internet-based video services). The A/V sources 226, thus, provide one or more A/V streams, such as television programs, VCR/DVD/Blue-ray/DVR videos, Internet-based content, etc.

The optional receivers 227 may be any appropriate or necessary audio/video devices, set top boxes or intermediary devices as may be used with the A/V sources 226, such as a cable TV converter box, a satellite TV converter box, a channel selector box, a TV descrambler box, a digital video recorder (DVR) device, a TiVo™ device, etc. The receivers 227 are considered optional, since some such A/V sources 226 do not require any such intermediary device. For embodiments that do not include the optional receivers 227, the A/V streams from the A/V sources 226 may pass directly to the display devices 101 or to the servers 104 or both. To pass the A/V streams to both, one or more A/V splitters (e.g., a coaxial cable splitter, HDMI splitter, etc.) may be used in place of the optional receivers 227.

Some types of the optional receivers 227 have separate outputs for audio and video, so some embodiments pass the video streams only to the display devices 101 and the audio streams only to the servers 104. On the other hand, some types of the optional receivers 227 have outputs only for the combined audio and video streams (e.g., coaxial cables, HDMI, etc.), so some embodiments pass the A/V streams only to the display devices 101, only to the servers 104 or to both (e.g., through multiple outputs or A/V splitters). For those embodiments in which the entire A/V streams are provided only to the display devices 101 (from either the A/V sources 226 or the optional receivers 227), the audio stream is provided from the display devices 101 (e.g., from a headphone jack) to the servers 104. For those embodiments in which the entire A/V streams are provided only to the servers 104 (from either the A/V sources 226 or the optional receivers 227), the video stream (or A/V stream) is provided from the servers 104 to the display devices 101.

The servers 104 provide the audio streams (e.g., properly encoded, packetized, etc.) to the WAPs 228. The WAPs 228 transmit the audio streams to the user devices 103. Depending on the embodiment, the WAPs 228 also transmit data between the servers 104 and the user devices 103 for the various other functions described herein. In some embodiments, the servers 104 also transmit and receive various data through another network or the Internet. In some embodiments, a server 104 may transmit an audio stream to another server 104 within a network, so that the audio stream can be further transmitted through a network access point 105 that is within range of the user device 103.

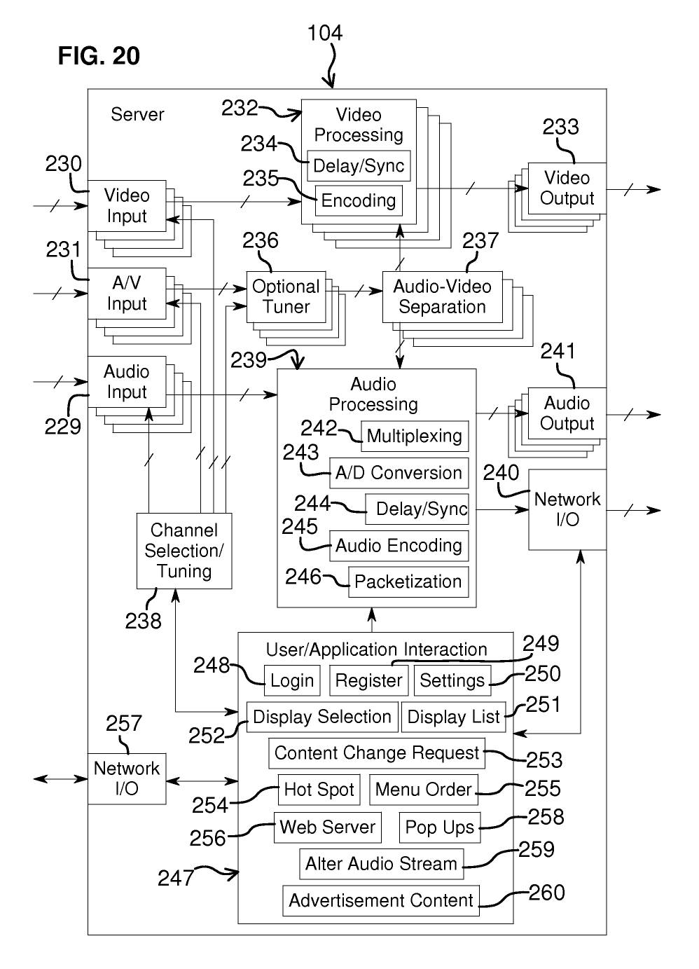

An example functional block diagram of the server 104 is shown in FIG. 20 in accordance with an embodiment of the present invention. It is understood that the present invention is not necessarily limited to the functions shown or described. Instead, some of the functions may be optional or not included in some embodiments, and other functions not shown or described may be included in other embodiments. Additionally, some connections between functional blocks may be different from those shown and described, depending on various embodiments and/or the types of physical components used in the server 104.

Each of the illustrated example functional blocks and connections between functional blocks generally represents any appropriate physical or hardware components or combination of hardware components and software that may be necessary for the described functions. For example, some of the functional blocks may represent audio processing circuitry, video processing circuitry, microprocessors, memory, software, networking interfaces, I/O ports, etc. In some embodiments, some functional blocks may represent more than one hardware component, and some functional blocks may be combined into a fewer number of hardware components.

In some embodiments, some or all of the functions are incorporated into one or more devices that may be located within the environment 100, as mentioned above. In other embodiments, some or all of the functions may be incorporated in one or more devices located outside the environment 100 or partially on and partially off premises, as mentioned above.

In the illustrated example, the server 104 is shown having one or more audio inputs 229 for receiving one or more audio streams, one or more video inputs 230 for receiving one or more video streams and one or more combined A/V inputs 231 for receiving one or more A/V streams. These input functional blocks 229-231 generally represent one or more I/O connectors and circuitry for the variety of different types of A/V sources 226 that may be used, e.g., coaxial cable connectors, modems, wireless adapters, HDMI ports, network adapters, Ethernet ports, stereo audio ports, component video ports, S-video ports, etc. Some types of video content may be provided through one of these inputs (from one type of A/V source 226, e.g., cable or satellite) and the audio content provided through a different input (from another type of A/V source 226, e.g., the Internet). Multiple language audio streams, for example, may be enabled by this technique. The video inputs 230 and A/V inputs 231 may be considered optional, so they may not be present in some embodiments, since the audio processing may be considered the primary function of the servers 104 in some embodiments. It is also possible that the social interaction and/or food/drink ordering functions are considered the primary functions in some embodiments, so the audio inputs 229 may potentially also be considered optional.

For embodiments in which the server 104 handles the video streams in addition to the audio streams, one or more video processing functional blocks 232 and one or more video outputs 233 are shown. The video outputs 233 may include any appropriate video connectors, such as coaxial cable connectors, wireless adapters, HDMI ports, network adapters, Ethernet ports, component video ports, S-video ports, etc. for connecting to the display devices 101. The video processing functional blocks 232 each generally include a delay or synchronization functional block 234 and a video encoding functional block 235.

In some embodiments, however, the sum of the video processing functions at 232 may simply result in passing the video stream directly through or around the server 104 from the video inputs 230 or the A/V inputs 231 to the video outputs 233. In other embodiments, the video stream may have to be output in a different form than it was input, so the encoding function at 235 enables any appropriate video stream conversions (e.g., from an analog coaxial cable input to an HDMI output or any other conversion). Additionally, since the video streams and audio streams do not necessarily pass through the same equipment, it is possible for the syncing of the video and audio streams to be off by an intolerable amount by the time they reach the display devices 101 and the user devices 103, respectively. The delay or synchronization functions at 234, therefore, enable synchronization of the video and audio streams, e.g., by delaying the video stream by an appropriate amount. For example, a generator may produce a video test pattern so that the appropriate delay can be introduced into the video stream, so that the video and audio are synchronized from the user's perspective (lip sync′d).

In this example, one or more optional tuner functional blocks 236 (e.g., a TV tuner circuit) may be included for a video input 230 or A/V input 231 that requires tuning in order to extract a desired video stream or A/V stream. Additionally, for embodiments in which the video and audio streams are received together (e.g., through a coaxial cable, HDMI, etc.), an audio-video separation functional block 237 may be included to separate the two streams or to extract one from the other. Furthermore, a channel selection/tuning functional block 238 may control the various types of inputs 229-231 and/or the optional tuners at 236 so that the desired audio streams may be obtained. Thus, some of the functions of the display devices 101 (as a conventional television) or of the optional receivers 227 may be incorporated into the servers 104. However, if only one audio stream for each input 229-231 is received, then the tuners at 236 and the channel selection/tuning functions at 238 may be unnecessary.

The one or more audio streams (e.g., from the audio inputs 229, the A/V inputs 231 or the audio-video separation functional block 237) are generally provided to an audio processing functional block 239. The audio processing functional block 239 generally converts the audio streams received at the inputs 229 and/or 231 into a proper format for transmission through a network I/O adapter 240 (e.g., an Ethernet port, USB port, etc.) to the WAPs 228 or network access points 105. Additionally, if it is desired to provide the audio streams to the display devices 101 as well, then the audio streams may also simply be transmitted through the audio processing functional block 239 or directly from the audio or A/V inputs 229 or 231 or the audio-video separation functional block 237 to one or more audio outputs 241 connected to the display devices 101.

Depending on the number, type and encoding of the audio streams, some of the illustrated audio processing functions at 239 may be optional or unnecessary. In this example, however, the audio processing functional block 239 generally includes a multiplexing functional block 242, an analog-to-digital (A/D) conversion functional block 243, a delay/synchronization functional block 244, an audio encoding (including perceptual encoding) functional block 245 and a packetization functional block 246. The functions at 242-246 are generally, but not necessarily, performed in the order shown from top to bottom in FIG. 20.

If the server 104 receives multiple components of one audio stream (e.g., left and right stereo components, Dolby Digital 5.1™, etc.), then the multiplexing function at 242 multiplexes the two streams into one for eventual transmission to the user devices 103. Additionally, if the server 104 receives more than one audio stream, then the multiplexing function at 242 potentially further multiplexes all of these streams together for further processing. If the server 104 receives more audio streams than it has been requested to provide to the user devices 103, then the audio processing functional block 239 may process only the requested audio streams, so the total number of multiplexed audio streams may vary during operation of the server 104.

If the received audio streams are analog, then the A/D conversion function at 243 converts the analog audio signals (using time slicing if multiplexed) into an appropriate digital format. On the other hand, if any of the audio streams are received in digital format, then the A/D conversion function at 243 may be skipped for those audio streams. If all of the audio streams are digital (e.g., all from an Internet-based source, etc.), then the A/D conversion functional block 243 may not be required.

Again, since the video streams and audio streams do not necessarily pass through the same equipment, it is possible for the syncing of the video and audio streams to be off by an intolerable amount by the time they reach or pass through the display devices 101 and the user devices 103, respectively. The delay or synchronization functions at 244, therefore, enable synchronization of the video and audio streams, e.g., by delaying the audio stream by an appropriate amount. (Alternatively, the audio delay/synchronization functions may be in the user devices 103, e.g., as describe below.) For example, a generator may produce an audio test pattern so that the appropriate delay can be introduced into the audio stream, so that the video and audio are synchronized from the user's perspective (lip sync′d). The delay/synchronization functional block 244 may work in cooperation with the delay/synchronization functional block 234 in the video processing functions at 232. The server 104, thus, may use either or both delay/synchronization functional blocks 234 and 244 to synchronize the video and audio streams. Alternatively, the server 104 may have neither delay/synchronization functional block 234 or 244 if synchronization is determined not to be a problem in all or most configurations of the overall A/V equipment (e.g., 101 and 103-105). Alternatively, the lip sync function may be external to the servers 104. This alternative may be appropriate if, for instance, lip sync calibration is done at setup by a technician. In some embodiments, if the audio and video streams are provided over the Internet, the audio stream may be provided with a sufficiently large lead over the video stream that synchronization could always be assured by delaying the audio stream at the server 104 or the user device 103.

The delay/synchronization functions at 234 and 244 generally enable the server 104 to address fixed offset and/or any variable offset between the audio and video streams. The fixed offset is generally dependant on the various devices between the A/V source 226 (FIG. 19) and the display devices 101 and the user devices 103. The display device 101, for example, may contain several frames of image data on which it would do advanced image processing in order to deliver the final imagery to the screen. At a 60 Hz refresh rate and 5 frames of data, for example, then a latency of about 83 ms may occur.

There are several ways to assure that the video and audio streams are synchronized from the perspective of the user 102. One method is to have the user 102 manually adjust the audio delay using a control in the application on the user device 103, which may send an appropriate control signal to the delay/synchronization functional block 244. This technique may be implemented, for instance, with a buffer of adjustable depth.

A second method is for the delay/synchronization functions at 234 and 244 to include a lip sync calibration generator, or for a technician to use an external lip-sync calibration generator, with which to calibrate the video and audio streams. The calibration may be done so that for each type of user device 103 and display device 101, the application sets the audio delay (via an adjustable buffer) to an appropriate delay value. For instance, a technician at a particular environment 100, may connect the calibration generator and, by changing the audio delay, adjust the lip sync on a representative user device 103 to be within specification. On the other hand, some types of the user devices 103 may be previously tested, so their internal delay offsets may be known. The server 104 may store this information, so when one of the user devices 103 accesses the server 104, the user device 103 may tell the server 104 what type of user device 103 it is. Then the server 104 may set within the delay/synchronization functional block 244 (or transmit to the application on the user device 103) the proper calibrated audio delay to use. Alternatively, the application on each user device 103 may be provided with data regarding the delay on that type of user device 103. The application may then query the server 104 about its delay characteristics, including the video delay, and thus be able to set the proper buffer delay within the user device 103 or instruct the server 104 to set the proper delay within the delay/synchronization functional block 244.

A third method is for the server 104 to timestamp the audio stream. By adjusting when audio is pulled out of a buffer on the user device 103, the user device 103 assures that the audio stream is lip sync′d to the video stream. Each server 104 may be calibrated for the delay in the video path and to assure that the server 104 and the application use the same time reference.

A fourth method is for the server 104 to transmit a low resolution, but lip sync′d, version of the video stream to the application. The application then uses the camera on the user device 103 to observe the display device 101 and correlate it to the video image it received. The application then calculates the relative video path delay by observing at what time shift the maximum correlation occurs and uses that to control the buffer delay.

In some embodiments, the video and audio streams may be synchronized within the following specs: Sara Kudrle et. al. (July 2011). “Fingerprinting for Solving A/V Synchronization Issues within Broadcast Environments”. Motion Imaging Journal (SMPTE). This reference states, “Appropriate A/V sync limits have been established and the range that is considered acceptable for film is +/−22 ms. The range for video, according to the ATSC, is up to 15 ms lead time and about 45 ms lag time.” In some embodiments, however, a lag time up to 150 ms is acceptable. It shall be appreciated that it may happen for the audio stream to lead the video stream by more than these amounts. In a typical display device 101 that has audio capabilities, the audio is delayed appropriately to be in sync with the video, at least to the extent that the original source is in sync.

In some embodiments, problems may arrive when the audio stream is separated from the video stream before reaching the display device 101 and put through, for instance, a separate audio system. In that case, the audio stream may significantly lead the video stream. To fix this, a variety of vendors offer products, e.g., the Hall Research AD-340™ or the Felston DD740™, that delay the audio by an adjustable amount. Additionally, the HDMI 1.3 specification also offers a lip sync mechanism.

Some embodiments of the present invention experience one or more additional delays. For example, there may be substantial delays in the WAPs 228 or network access points 105 as well as in the execution of the application on the user devices 103. For instance, Wi-Fi latency may vary widely depending on the number of user devices 103, interference sources, etc. On the user devices 103, processing latency may depend on whether or not the user device 103 is in power save mode or not. Also, some user devices 103 may provide multiprocessing, so the load on the processor can vary. In some embodiments, therefore, it is likely that the latency of the audio path will be larger than that of the video path.

In some embodiments, the overall system (e.g., 101 and 103-105) may keep the audio delay sufficiently low so that delaying the video is unnecessary. In some embodiments, for example, WEP or WPA encryption may be turned off. In other embodiments, the user device 103 is kept out of any power save mode.

The overall system (e.g., 101 and 103-105) in some embodiments provides a sync solution without delaying the video signal. For example, the server 104 separates the audio stream before it goes to the display devices 101 so that the video delay is in parallel with the audio delay. When synchronizing, the server 104 takes into consideration that the audio stream would have been additionally delayed if inside the display device 101 so that it is in sync with the video stream. Thus, any extra audio delay created by the network access points 105 and the user device 103 would be in parallel with the video delay.

In some embodiments, the video stream may be written into a frame buffer in the video processing functional block 232 that holds a certain number of video frames, e.g., up to 10-20 frames. This buffer may cause a delay that may or may not be fixed. The server 104 may further provide a variable delay in the audio path so that the audio and video streams can be equalized. Additionally, the server 104 may keep any variation in latency within the network access point 105 and the user device 103 low so that the audio delay determination is only needed once per setup.

In some embodiments, the overall system (e.g., 101, 103-105) addresses interference and moving the user device 103 out of power save mode. In some cases, the delay involved with WEP or WPA security, may be acceptable assuming that it is relatively fixed or assisted by special purpose hardware in the user device 103.

If the audio or video delay is too variable, some embodiments of the overall system (e.g., 101, 103-105) provides alternatively or additionally another mechanism for synchronization. The overall system (e.g., 101, 103-105) may utilize solutions known in the VoIP (voice over Internet protocol) or streaming video industries. These solutions dynamically adjust the relative delay of the audio and video streams using, for instance, timestamps for both data streams. They generally involve an audio data buffer in the user device 103 with flow control and a method for pulling the audio stream out of the buffer at the right time (as determined by the time stamps) and making sure that the buffer gets neither too empty nor too full through the use of flow control. In addition or in the alternative, the overall system (e.g., 101, 103-105) may perform more or less compression on the audio depending on the average available bandwidth.

The audio encoding functions at 245 (sometimes called codecs) generally encode and/or compress the audio streams (using time slicing if multiplexed) into a proper format (e.g., MP3, MPEG-4, AAC (E)LD, HE-AAC, S/PDIF, etc.) for use by the user devices 103. (The degree of audio compression may be adaptive to the environment 100.) Additionally, the packetization functions at 246 generally appropriately packetize the encoded audio streams for transmission through the network I/O adapter 240 and the WAPs 228 or network access points 105 to the user devices 103, e.g., with ADTS (Audio Data Transport Stream), a channel number and encryption if needed.

In this example, the server 104 also has a user or application interaction functional block 247. These functions generally include those not involved directly with the audio streams. For example, the interaction functions at 247 may include login and register functional blocks 248 and 249, respectively. The login and register functions at 248 and 249 may provide the screens 120, 125 and 134 (FIGS. 4, 5 and 6, respectively) to the user devices 103 and the underlying functions associated therewith for the users 102 to sign up or login to the servers 104, as described above.

In this example, the interaction functions at 247 may include a settings functional block 250. The settings functions at 250 may provide the screens 166, 170 and 174 (FIGS. 11, 12 and 13, respectively) to the user devices 103 and the underlying functions associated therewith for the users 102 to set various options for the application as they relate to the servers 104, including storing setting information and other functions described above. (Some of the underlying functions associated with the screens 166, 170 and 174, however, may be performed within the user devices 103 without interaction with the servers 104.)

In this example, the interaction functions at 247 may include a display list functional block 251. The display list functions at 251 may provide a list of available display devices 101 to the user devices 103 for the user devices 103 to generate the display device selection screen 159 shown in FIG. 8 and the language pop-up window 164 shown in FIG. 9.

In this example, the interaction functions at 247 may include a display selection functional block 252. When the user 102 selects a display device 101 from the display device selection screen 159 shown in FIG. 8, the display selection functions at 252 may control the channel selection/tuning functions at 238, the inputs 229-231, the tuners at 236 and the audio processing functions at 239 as necessary to produce the audio stream corresponding to the selected display device 101.

In this example, the interaction functions at 247 may include a content change request functional block 253. The content change request functions at 253 generally enable the users 102 to request that the TV channel or video content being provided over one of the display devices 101 to be changed to something different. The application on the user devices 103 may provide a screen option (not shown) for making a content change request. Then a pop-up window (not shown) may be provided to other user devices 103 that are receiving the audio stream for the same display device 101. The pop-up window may allow the other users 102 to agree or disagree with the content change. If a certain percentage of the users 102 agree, then the change may be made to the selected display device 101. The change may be automatic through the display selection functions at 252, or a manager or other person within the environment 100 may be alerted (e.g., with a text message through a multifunctional mobile device carried by the person) to make the change. By having the manager or other person within the environment 100 make the change, the owner/operator of the environment 100 may limit inappropriate public content within the environment 100 and may choose video streams that would attract the largest clientele. In either case, it may be preferable not to allow the users 102 to change the video content of the display devices 101 (or otherwise control the display devices 101) without approval in order to prevent conflicts among users 102.

In this example, the interaction functions at 247 may include a hot spot functional block 254. The hot spot functions at 254 may allow the users 102 to use the servers 104 and network access points 105 as a conventional Wi-Fi “hot spot” to access other resources, such as the Internet. The bandwidth made available for this function may be limited in order to ensure that sufficient bandwidth of the servers 104 and the network access points 105 is reserved for the audio streaming, food/drink ordering and social interaction functions within the environment 100.

In this example, the interaction functions at 247 may include a menu order functional block 255. The menu order functions at 255 may provide the screen options and underlying functions associated with the food and drink ordering functions described above with reference to FIGS. 14-18. A list of available menu items and prices for the environment 100 may, thus, be maintained within the menu order functional block 255.

In this example, the interaction functions at 247 may include a web server functional block 256. The web server functions at 256 may provide web page files in response to any conventional World Wide Web access requests. This function may be the means by which data is provided to the user devices 103 for some or all of the functions described herein. For example, the web server functional block 256 may provide a web page for downloading the application for the user devices 103 or an informational web page describing the services provided. The web pages may also include a restaurant or movie review page, a food/beverage menu, advertisements for specials or upcoming features. The web pages may be provided through the network access points 105 or through the Internet, e.g., through a network I/O adapter 257.

The network I/O adapter 257 may be an Ethernet or USB port, for example, and may connect the server 104 to other servers 104 or network devices within the environment 100 or off premises. The network I/O adapter 257 may be used to download software updates, to debug operational problems, etc.

In this example, the interaction functions at 247 may include a pop ups functional block 258. The pop ups functions at 258 may send data to the user devices 103 to cause the user devices 103 to generate pop up windows (not shown) to provide various types of information to the users 102. For example, drink specials may be announced, or a notification of approaching closing time may be given. Alternatively, while the user 102 is watching and listening to a particular program, trivia questions or information regarding the program may appear in the pop up windows. Such pop ups may be part of a game played by multiple users 102 to win free food/drinks or loyalty points. Any appropriate message may be provided as determined by the owner/operator of the environment 100 or of the servers 104.

In this example, the interaction functions at 247 may include an alter audio stream functional block 259. The alter audio stream functions at 259 may allow the owner, operator or manager of the environment 100 to provide audio messages to the users 102 through the user devices 103. This function may interrupt the audio stream being provided to the user devices 103 for the users 102 to watch the display devices 101. The existing audio stream may, thus, be temporarily muted in order to provide an alternate audio stream, e.g., to announce drink specials, last call or closing time. The alter audio stream functional block 259 may, thus, control the audio processing functions at 239 to allow inserting an alternate audio stream into the existing audio stream. Furthermore, the alter audio stream functions at 259 may detect when a commercial advertisement has interrupted a program on the display devices 101 in order to insert the alternate audio stream during the commercial break, so that the program is not interrupted.

In this example, the interaction functions at 247 may include an advertisement content functional block 260. The advertisement content functions at 260 may provide the alternate audio streams or the pop up window content for advertisements by the owner/operator of the environment 100 or by beverage or food suppliers or manufacturers or by other nearby business establishments or by broad-based regional/national/global business interests. The advertisements may be personalized using the name of the user 102, since that information may be provided when signing up or logging in, and/or appropriately targeted by the type of environment 100. Additionally, the servers 104 may monitor when users 102 enter and leave the environment 100, so the owners/operators of the environment 100 may tailor advertised specials or programs for when certain loyal users 102 are present, as opposed to the general public. In some embodiments, the servers 104 may offer surveys or solicit comments/feedback from the users 102 or announce upcoming events.

Other functions not shown or described may also be provided. For example, the servers 104 may provide data to the user devices 103 to support any of the other functions described herein. Additionally, the functions of the servers 104 may be upgraded, e.g., through the network I/O adapter 257.

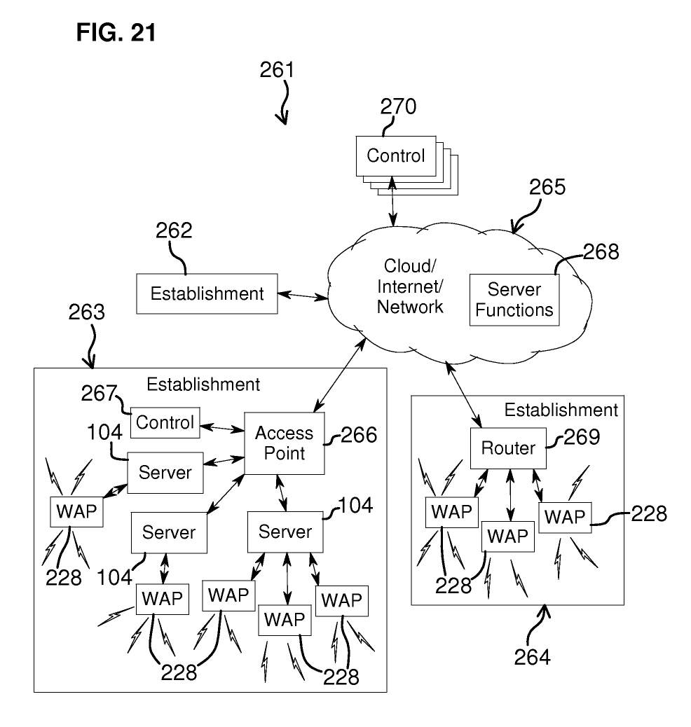

An example overall network 261, in accordance with an embodiment of the present invention, that may include multiple instances of the environment 100 is shown in FIG. 21. The example network 261 generally includes multiple environments 100 represented by establishments 262, 263 and 264 connected to a cloud computing system or the Internet or other appropriate network system (the cloud) 265. Some or all of the controls or data for functions within the establishments 262-264 may originate in the cloud 265.

The establishment 263 generally represents embodiments in which some or all of the functions of the servers 104 are placed within the environment 100. In this case, the establishment 263 generally includes one or more of the servers 104 and WAPs 228 (or network access points 105) on premises along with a network access point 266 for accessing the cloud 265. A control device 267 may be placed within the establishment 263 to allow the owner/operator/manager of the establishment 263 or the owner/operator of the servers 104 to control or make changes for any of the functions of the servers 104 and the WAPs 228.

The establishment 264 generally represents embodiments in which some or all of the functions of the servers 104 are placed within the cloud 265. In this case, a server functions functional block 268 is shown in the cloud 265 and a router 269 (or other network devices) is shown in the establishment 264. The server functions functional block 268 generally represents any physical hardware and software within the cloud 265 that may be used to provide any of the functions described herein (including, but not limited to, the functions described with reference to FIG. 20) for the establishment 264. For example, the audio streams, video streams or A/V streams may be provided through, or from within, the cloud 265, so the server functions at 268 process and transmit the audio streams (and optionally the video streams) as necessary to the establishment 264 through the router 269 and the WAPs 228 (or network access points 105) to the user devices 103 (and optionally the display devices 101) within the establishment 264.

One or more control devices 270 are shown connected through the cloud 265 for controlling any aspects of the services provided to the establishments 262-264, regardless of the placement of the server functions. For example, software upgrades may be provided through the control devices 270 to upgrade functions of the servers 104 or the application on the user devices 103. Additionally, the advertisement content may be distributed from the control devices 270 by the owner/operators of the server functions or by business interests providing the advertisements.

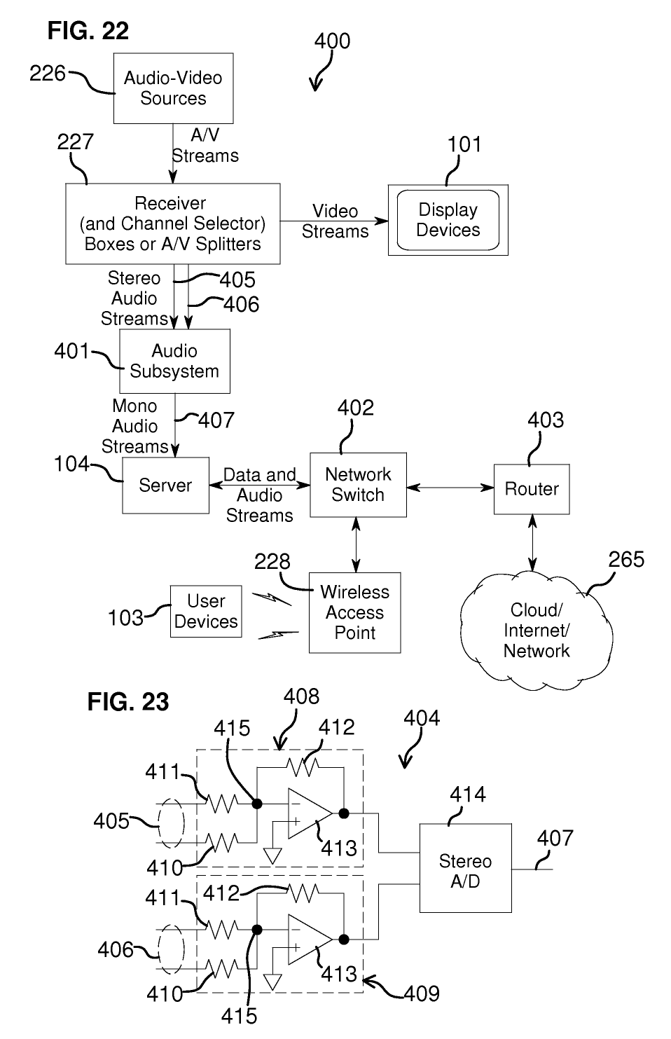

FIG. 22 shows a simplified schematic diagram of at least part of an example system 400 that may be used in the environment 100 shown in FIG. 1 in accordance with another embodiment of the present invention. This embodiment enables users 102 to be able to listen to the audio stream associated with one of the display devices 101 with one ear and to listen simultaneously to ambient sounds in the environment 100 with their other ear. These users 102 may thus enjoy the audio content with the video content provided by one of the available display devices 101 while also participating in conversations with other people in the environment 100. Alternatively, the audio stream associated with one of the display devices 101 (e.g., showing a particularly popular sporting event) may be provided as the ambient sound for all people in the entire environment 100, so this embodiment may allow some of the users 102 to listen to the ambient sound audio stream with one ear, while also listening to the audio stream associated with a different display device 101 with their other ear.

To listen to both of the audio sources (ambient and streaming through their user device 103) a user 102 may put an earbud or headphone speaker in or on one ear, and leave the other ear uncovered or unencumbered. The user 102 may thus hear the selected audio stream through the headphone speaker while listening to the ambient sound through the uncovered ear. If the selected audio stream has both left and right stereo audio components, but the user 102 uses only one headphone speaker, then part of the audio content may be lost. According to the present embodiment, however, the stereo audio streams that may be presented to some or all of the users 102 through their user devices 103 may be converted to mono audio streams prior to transmission to the user devices 103. In this manner, the stereo-to-mono audio feature enables the users 102 to use only one conventional earbud or headphone speaker in order to hear the full stereo sound in only one ear, albeit without the stereo effect.

In alternative embodiments, the users 102 may desire to attach a speaker (e.g., a portable table top speaker) to their user device 103, so that the audio stream can be heard by anyone within an appropriate listening distance of the speaker. In such embodiments, the audio stream is preferably mono, as in the previous embodiment, since such speakers typically have limited capability.

According to the illustrated embodiment, the example system 400 generally includes any appropriate number and/or combination of the A/V source 226, the receiver 227, the display device 101, the server 104, and the WAPs 228, as shown in FIGS. 1, 19, and 21 and described above. Additionally, the example system 400 generally includes one or more audio subsystems 401, a network switch 402, and a router 403, among other possible components not shown for simplicity of illustration and description. (In some embodiments, some of these components may be optional or may not be included.) In various embodiments, some of the functions of the receiver 227, the audio subsystem 401, and the server 104 may be in one or the other of these devices or in one combined device, e.g., the audio processing functions at 239 (FIG. 20) in the server 104 may perform some or all of the functions of the audio subsystem 401, and the tuners at 236 and the audio-video separation functional block 237 may perform some or all of the functions of the receiver 227.

In the illustrated embodiment, the A/V content is generally received from the A/V sources 226 by the receivers 227. The video content streams are transmitted by the receivers 227 to the display devices 101, and the stereo audio streams are provided to the audio subsystem 401. At least a portion of the audio subsystem 401 converts the stereo audio streams into mono audio streams. (Alternatively, the receivers 227 may perform the stereo-to-mono conversion.) There are a variety of commercial devices that can perform the conversion function, as well as additional encoding functions, e.g., the TI PCM2903C available from Texas Instruments, Inc.

For example, a conversion circuit 404 shown in a simplified schematic diagram in FIG. 23 may form at least part of the audio subsystem 401 for converting input analog stereo audio streams (e.g., 405 and 406) into one or more output multiplexed digital mono audio streams (e.g., 407). The conversion circuit 404 may include one or more stereo-to-mono conversion circuits 408 and 409 (e.g., resistors 410, 411, and 412, and operational amplifier 413) and a stereo analog-to-digital converter (ADC) and multiplexor 414 to produce the multiplexed digital mono audio streams (e.g., 407) from the analog stereo audio streams (e.g., 405 and 406). The operational amplifier 413 buffers the inputs 405 or 406. The resistor 412 controls the gain. A node 415 is commonly called a summing junction, at which the left and right stereo audio signals are summed to one mono signal. The ADC 414 generally includes two internal ADCs to handle stereo inputs, but in this configuration the ADC 414 handles two mono inputs from the conversion circuits 408 and 409.

The server 104 receives (e.g., at input 229, FIG. 20) the multiplexed digital mono audio streams (e.g., 407). (Alternatively, the server 104 may perform any of the appropriate audio processing functions at 239 (FIG. 20). For example, the A/D conversion or multiplexing functions mentioned previously may be performed in the server 104, e.g., at 243 and/or 242 (FIG. 20)). The mono audio streams are encoded at 245 and packetized at 246 in the server 104. The digital audio streams are thus compressed, e.g., by a codec such as MPEG 3, AAC, or Opus, for transmitting through the audio outputs 241 or the network I/O adapter 240 to a Local Area Network (LAN).

The LAN generally includes any appropriate combination of Ethernet, WIFI, Bluetooth, etc. components. For example, the LAN may include the network switch 402, the WAPs 228, and the router 403. The router 403 is generally for optionally connecting to a WAN, such as the Internet or the Cloud 265, e.g., for purposes described above.

The audio streams are transmitted through the network switch 402 and the WAPs 228 for wireless transmission to the user devices 103. The audio streams may use any appropriate protocol, e.g., S/PDIF, TCP or UDP. The UDP protocol may be less reliable than TCP, but may be used when there is more concern for speed and efficiency and less concern for end-to-end reliability, since a few lost packets are not so important in audio streaming.

The network switch 402 and the WAPs 228 may also be used to transmit data back from the user devices 103 to the server 104 (and through the router 403 to the Cloud 265). With this functionality, in some embodiments, the users 102 may select whether to hear the audio streams in stereo or mono. In this case, the interaction functions at 247 (FIG. 20) may present an appropriate menu on the user devices 103 through the settings functions at 250, so the users 102 may make their desired selection to send a command to the server 104 to either use or bypass the stereo-to-mono functions described herein.

In addition to the advantage of enabling greater flexibility in how the users 102 listen to their selected audio streams, the present embodiment enables additional advantages. For example, when two left and right stereo audio streams are combined into one mono audio stream, some of the components downstream from the combination point may be simplified. In other words, when the number of audio streams is reduced, the number of audio components for handling the streams may also be reduced. Additionally, the bandwidth of components necessary for digital transmission of the audio streams through the server 104, the network switch 402, and the WAPs 228 can also be reduced. In this manner, the size, complexity, and cost of these components can be reduced.

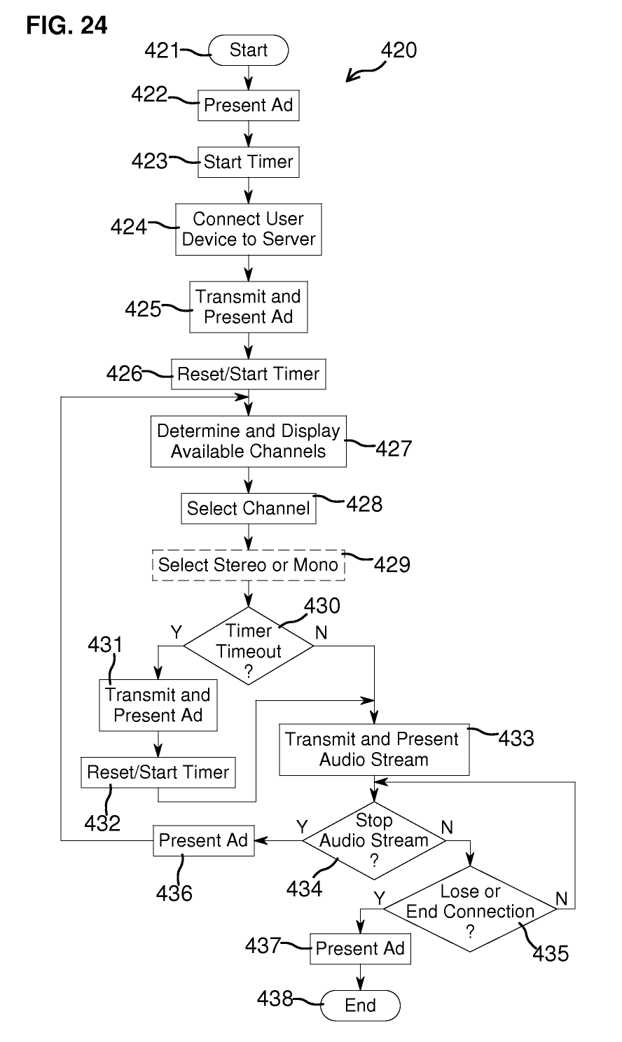

FIG. 24 shows a simplified flow chart of an example process 420 for at least some of the functions of the servers 104 and the user devices 103 in accordance with another embodiment of the present invention. (Variations on this embodiment may use different steps or different combinations of steps or different orders of operation of the steps.) This embodiment enables advertisements to be presented to the users 102 at various times during operation of the application that runs on the user devices 103. For example, an ad may be presented upon starting or launching the application on the user devices 103, upon the user devices 103 connecting to or logging into the server 104, upon selecting an audio stream associated with one of the display devices 101, and/or upon leaving the environment 100 or losing or ending the WIFI signal to the WAPs 105 or 228.

The ads may be stored on the server 104 and may be uploaded to the server 104 from a storage medium (e.g., DVD, flash drive, etc.) at the server 104 or transmitted to the server 104 from the Cloud 265, e.g., under control of the advertisement content functions at 260 (FIG. 20), the control devices 270 and/or other appropriate control mechanisms. Alternatively, the ads may be transmitted from the Cloud 265 to the user devices 103 without interacting with the server 104. In either case, the ads may be streamed to the user device 103 when needed or may be uploaded to and stored on the user device 103 for use at any appropriate time.

Since one of the purposes of the application is to present audio streams through the user devices 103, the ads may ideally also be audio in nature. Thus, the users may hear the ads even if, as may often be the case, they are not looking at the display screen of their user devices 103. However, since many types of the user devices 103 can also present images or video, the ads may alternatively be imagery, video or any combination of imagery, video, and audio.

According to the example process 420, upon starting (at 421) the application on the user device 103, an ad may be presented (at 422) through the user device 103, e.g., while the application is launching, upon completing the launch and/or while connecting to the WAP 228 and the server 104. The ad at this time may have previously been loaded onto and stored in the user device 103, e.g., during a previous running of the application. However, if no ad is already available on the user device 103, and since the application has not yet connected to the server 104 to load an ad, the ad presentation at 422 may be skipped.

In some embodiments, after each time an ad is presented through the user device 103, a timer may be started or reset (e.g., at 423). (The timer is not started if the ad is not presented.) This timer may ensure that another ad is not presented before the timer has timed out, e.g., after a few minutes. In this manner, the users 102 are not subjected to the ads too frequently, e.g., when the users 102 change selected channels often.

At 424, the application on the user device 103 connects to the WAP 228 and then to the server 104. At this point, the application can now download an ad from the server 104, so the server 104 is instructed to transmit (at 425) an ad to the user device 103. Alternatively, if the user device 103 already has an ad stored in memory that may be presented in the subsequent steps, then the transmit and download may be skipped. In another alternative, the application may download any number of ads to be immediately presented (e.g., streaming the ad) or stored for later presentation. If the previous ad was not presented at 422 or the timer started at 423 has timed out, then a streamed or stored ad may be presented through the user device 103 to the user 102. The timer is then reset/started at 426. If the ad was presented at 422 and the timer started at 423 has not timed out, however, then 425 and 426 may be skipped.

At 427, the application determines the channels or audio streams that are available, as described above. This data is then presented (e.g., by the interaction functions at 247, FIG. 20) through the display screen of the user device 103 for the user 102 to make a selection. At 428, the user 102 inputs a selection of the channel or audio stream, and the application transmits the selection to the server 104. Additionally, in some embodiments, the user 102 may also select (at 429) to receive the audio stream in stereo or mono, as described above.

Before the selected audio stream is presented to the user 102 through the user device 103, if the timer has timed out (or has not yet been started), as determined at 430, then at 431 the server 104 may be instructed to transmit an ad for the user device 103 to download and present to the user 102. (Alternatively, for each transmit/download step described herein, if the user device 103 already has an ad stored in memory that may be used, then the transmit/download may be skipped, and the application may present the ad currently stored on the user device 103 to the user 102.) At 432, the timer is reset or started. After presenting the ad, or if the timer has not yet timed out (as determined at 430) after the audio stream selection has been made, then at 433 the server 104 may be instructed to transmit the selected audio stream for the application on the user device 103 to present to the user 102. Alternatively, transmission of the selected audio stream may begin during (or at least before the end of) the ad presentation, so that the selected audio stream is almost immediately ready for presentation as soon as the ad has completed.

During each ad presentation described herein, since the video content in which the user 102 is interested is available on one of the display devices 101 and not dependent on the operation of the user device 103 or the application thereon, the user 102 may view and enjoy the full unobstructed and unaltered video content during the entire time while the ad is being presented. Additionally, in some embodiments, the user 102 may interrupt any of the ad presentations, e.g., by a keypad input, a touch screen input or a prescribed movement of the user device 103 (for those user devices that have motion sensors or accelerometers). The ad presentation interruption may be done at any time during the ad presentation or only after a certain amount of time has elapsed. If the ad is interrupted, then the application on the user device 103 may begin presenting (at 433) the selected audio stream as soon as it is ready. Additionally, the timer may then be reset or started (at 432) for the same amount of time as in other reset/start steps or for a different amount of time, e.g., the ad interruption may result in the timer being set for a shorter time period, so that the next ad presentation may potentially be started sooner than if the user 102 had allowed the ad to play to conclusion.

The application continues to present the audio stream to the user 102 while continually checking whether the user 102 has stopped the audio stream presentation (as determined at 434) or the user device 103 has lost or somehow ended the connection with the WAP 228 and the server 104 (as determined at 435). If the user 102 has stopped the audio stream presentation (as determined at 434), then the application may (at 436, if the timer has timed out) present an ad again and reset the timer. The application may then return to 427 to display the available channels or audio streams again. If the connection to the WAP 228 and/or the server 104 is lost (e.g., by software/hardware malfunction or the user device 103 leaving the environment 100) or is ended (e.g., by an action by the user 102), as determined at 435, then the application may present (at 437) to the user 102 any ad that had already been stored on the user device 103. The process 420 may then end (at 438) or the application may present any other appropriate menu option to the user 102.

In some embodiments, the server 104 may transmit an ad to the user device 103 at any time while the server 104 and the user device 103 are connected, including in the background while performing other interactions with the user device 103, e.g., multiplexed with the selected audio stream while transmitting the selected audio stream, while waiting to receive a channel selection from the user device 103, etc. In this manner, the ad may be downloaded onto the user device 103 in advance of a time when the ad is to be presented. Thus, the user device 103 may begin presenting the ad with minimal delay at each presentation time. Furthermore, the ad transmission may be repeated for additional ads that may replace or supplement previously transmitted ads, so the user device 103 may almost always have one or more ads ready to be presented at any time.

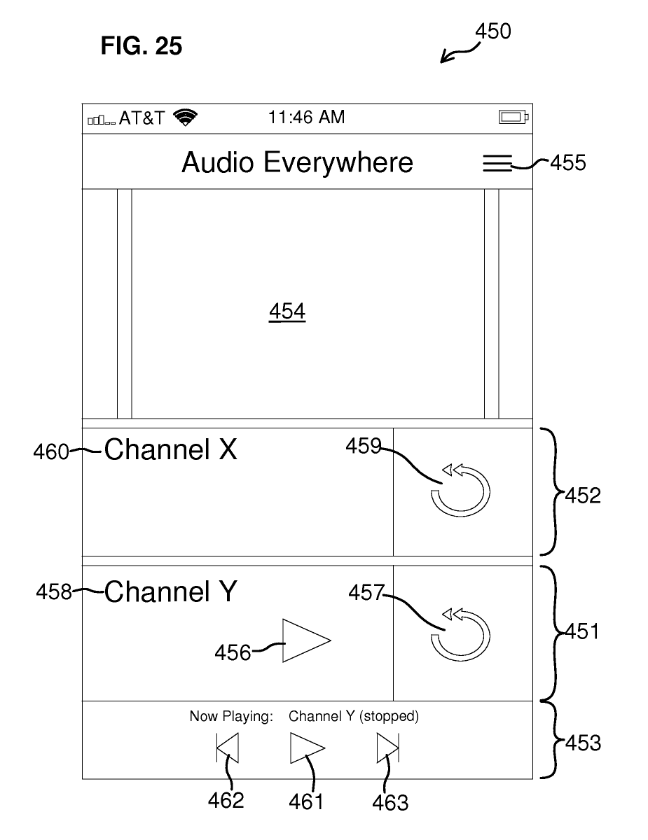

FIG. 25 is a simplified example of a view of a user interface 450 for an application running on the user device 103 in accordance with another embodiment of the present invention. (This application may be part of any of the previously described applications on the user device 103. Additionally, the illustrated view of the user interface 450 may be a default view that is displayed on the display screen of the user device 103 while the selected audio stream is being presented.) This application enables recording, in addition to streaming, of one or more selected audio streams associated with one or more of the display devices 101. With this recording feature, if the user 102 is interrupted, e.g., by a phone call or a conversation with another person in the environment 100, then the audio stream may be paused for a period of time and then resumed, so the missed part of the audio stream may be played back.

In some embodiments, if the user device 103 is a mobile phone, then the recording feature may be automatically initiated in response to receiving a phone call, and the end of the phone call may automatically cause the audio stream to resume. Additionally or in the alternative, the recording feature may be initiated by the user 102 making a keypad or touchscreen input, and the resume may be caused by another keypad or touchscreen input.

Since the presentation of the video stream on the display device 101 associated with the selected audio stream is generally not affected by the application running on the user device 103, the pausing of the selected audio stream is likely to cause the selected audio stream to be out of sync with the video stream. In some embodiments, therefore, when presentation of the selected audio stream is resumed, the playback speed may be increased by an appropriate factor (e.g., 1.1× to 2×) to a higher-than-normal speed until the selected audio stream catches up with the video stream, and then streaming of the selected audio stream may proceed at a normal rate. In this case, the recording feature continues to record the incoming audio stream until the high-speed playback catches up with the live stream.

In the illustrated embodiment, the user interface 450 includes various control features. Some of these features may be optional, or not included in some embodiments; whereas other features not shown may be included in still other embodiments. For example, the user interface 450 is shown including an active channel region 451, an inactive channel region 452, a playback control region 453, an information region 454, and a drop-down menu icon 455, among other regions, icons, etc. The active channel region 451 is shown including a play/pause icon 456, a rewind icon 457, and a channel indicator 458 (e.g., for Channel Y). The inactive channel region 452 is shown including a rewind icon 459, and a channel indicator 460 (e.g., for Channel X). The information region 454 is shown including a play/pause icon 461, a rewind icon 462, and a fast forward or skip icon 463.

The playback control region 453 shows that the audio stream for Channel Y is currently playing, but the audio stream is stopped. This condition may have occurred when the audio stream was paused, as described above. To restart the audio stream, the user 102 may touch the play/pause icon 456 or 461. Upon doing so, the user device 103 may begin playing the audio stream for Channel Y at the point where it was paused.

In FIG. 25, since the audio stream is currently stopped, the play/pause icon 456 or 461 looks like a typical right-pointing “play” triangle icon. When the audio stream is not stopped, on the other hand, the play/pause icon 456 or 461 may switch to look like a typical “pause” icon with parallel vertical bars. The user 102 may thus pause the audio stream presentation by touching the “pause” icon and start the audio stream presentation by touching the “play” icon.

In some embodiments, the user device 103 may continuously record the audio stream, even though it is not paused. In this manner, the user device 103 may store a certain amount of the most recently presented audio content, e.g., the most recent few seconds or few minutes. At any time, therefore, the user 102 may touch the rewind icon 457 or 462 to cause the audio presentation to rewind to an earlier point in the stream and replay some portion of the stored audio content for the currently playing channel. Again, the replayed portion may optionally be presented at an increased playback speed until it catches up with the live stream. With this feature, if the user 102 forgets to pause the audio stream presentation when distracted away from the audio content, e.g., when speaking with a person in the environment 100, the user 102 may cause the missed portion of the audio stream to be repeated, so as not to miss any of it. Additionally, in some embodiments, repeated touching of the rewind icon 457 or 462 may cause the audio playback to step back a set amount of time, e.g., a few seconds, until the audio playback reaches the point at which the user 102 stopped paying attention or runs out of stored audio content. On the other hand, touching the fast forward or skip icon 463 may cause the playback of the stored audio content to skip forward to a later point in the playback or all the way to the live stream.

One reason, among other potential reasons, for providing the inactive channel region 452 in the illustrated embodiment is to enable the user 102 to switch quickly to this channel, e.g., when the user 102 is interested in the video content of two different display devices 101. By touching anywhere in the inactive channel region 452, the user device 103 may switch to the audio stream of the second channel, so that the second channel (channel X) becomes the active channel and the first channel (channel Y) becomes the inactive channel. The user device 103 may thus send a new request to the server 104 to transmit the audio stream associated with the second channel.

To minimize any delay in making the switch between channels, however, some embodiments may enable receiving the audio stream for the inactive channel while presenting and/or recording the audio stream for the active channel. In this case, the user device 103 does not need to send a new request to the server 104. Instead, the user device 103 may simply start to present from the second audio stream, since the user device 103 is already receiving it. Additionally, the user device 103 may continue to receive the first audio stream, so that a switch back to the first channel may also be done with minimal delay.

Furthermore, in some embodiments, the user device 103 may record both audio streams for the two channels (X and Y). In this case, the rewind feature described above may be used with both channels, regardless of which channel is currently active. Touching the rewind icon 459 for the inactive channel, therefore, may not only cause the user device 103 to switch from the first to the second channel, but also to step backward in the stored audio content of the second channel to present a portion of the second audio stream that the user 102 may have missed. The user 102 may thus keep up with the audio content associated with two different display devices 101 by frequently switching between the two channels and listening to the recorded audio content at a higher-than-normal playback speed. Additionally, even if the user 102 is interrupted from both audio streams, e.g., by a phone call, the user 102 may get caught up with both audio streams after returning from the interruption.

In some embodiments, the recording and channel switching functions are performed by the application running on the user device 103, while the server 104 is enabled simply to transmit one or more audio streams to the user device 103. In other embodiments, some of the recording and/or channel switching functions are performed by the server 104, e.g., the server 104 may maintain in memory the most recent few minutes of audio content for all available audio streams associated with all of the display devices 101, and the server 104 may pause and resume the transmission of the audio streams. In this case, the rewind feature may send a request from the user device 103 to the server 104 with a specified starting point within the recorded audio stream at which to begin the audio transmission. In some embodiments, only the minimum necessary functions (e.g., the user interface functions) are enabled on the user device 103.

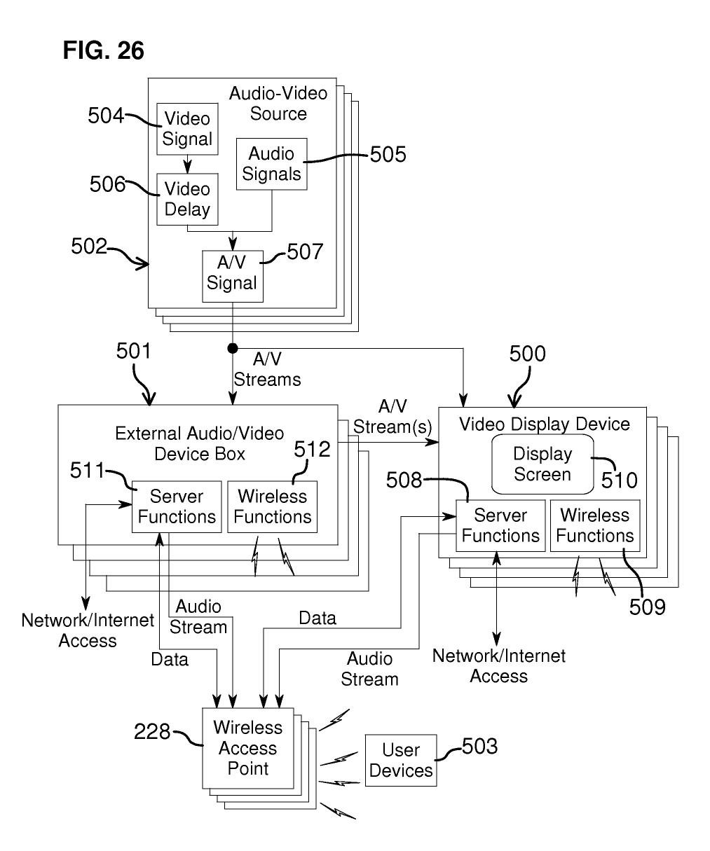

In accordance with some embodiments, some or all of the features of the server 104, along with other appropriate features, may be incorporated into the display devices 101, the receivers 227 or other appropriate video devices, instead of being incorporated in separate servers. In such embodiments, the server 104 may be eliminated or optional within the environment 100. FIG. 26 shows an example architecture for connecting at least some of the A/V equipment within the environment 100 in accordance with these embodiments of the present invention. Various features are enabled by this architecture. For example, some of these embodiments may use multiple video display devices 500, while other embodiments may use just one of the video display devices 500. Furthermore, some of these embodiments involve multiple audio streams that correspond to just one video stream, so there may be more available audio streams than there are available video streams. Other variations and features will also be described.

In addition to the one or more video display devices 500, the A/V equipment for these embodiments also generally includes one or more external audio-video device boxes 501, one or more audio-video sources 502, and one or more wireless access points 228 (e.g., the network access points 105 of FIG. 1). This A/V equipment is generally used with one or more user devices 503, which may be similar to the above described user devices 103, but include additional features and functions described below. Some of these elements or the described components thereof or connections therebetween may be unnecessary or optional in some variations of these embodiments.

The A/V sources 502 may be any available or appropriate A/V stream source for any type of audio-video content program. For example, the A/V sources 502 may be any combination of A/V content production sources, such as a TV network (e.g., NBC, ABC, CBS, CW, CNN, FOX, ESPN, etc.) or a communication network based video streaming service (e.g., Hulu, Netflix, Amazon Prime, YouTube, etc.), that may be received through any appropriate combination of transmission channels, such as cable TV, TV antennas, over-the-air TV broadcasts, satellite dishes, communication networks, the Internet, cellphone networks, etc. The A/V sources 502, thus, provide one or more A/V streams for use by the other A/V equipment in some of the embodiments. In some embodiments, however, the A/V sources 502 are unnecessary or optional. Typically, the A/V sources 502 are external and remote from the environment 100. In some embodiments as described below, the external audio-video device boxes 501 may serve as A/V sources that produce audio-video streams internally, e.g., from removable or non-removable storage media.

In some embodiments, the A/V sources 502 generally include components for video signal generation 504, components for audio signal generation 505, a video delay module 506, and an audio-video signal transmission module 507. The components for video signal generation 504 and audio signal generation 505 generally produce corresponding video signals and audio signals, respectively, for any appropriate audio-video content program. The audio-video signal transmission module 507 transmits the completed A/V streams to the various environments 100 with the video display devices 500 and/or the external audio-video device boxes 501. The video delay module 506 is described below.

Multiple audio-video content programs, each having or being represented by at least one video signal or stream, may be produced at the components for video signal generation 504 and audio signal generation 505. At least one audio signal is produced for each video signal or stream, and in some embodiments multiple types of audio signals may be produced for a single corresponding video signal of an audio-video content program. Such multiple audio signals corresponding to a single video signal may include audio signals in different languages and audio signals (regardless of a same or different language) having different content, among other potential examples. (This feature may be considered an advance over the language or closed-caption selection pop-up window 164 functions described above with respect to FIG. 9.)

Situations in which multiple audio signals may be produced for the same video signal, but with different audio content, may include a sporting event that is televised with audio commentary by more than one announcer, each with a different point of view. For example, each team participating in the sporting event (or the fans of the teams) may have a different preferred play-by-play announcer and/or color commentator. The A/V source 502 that is televising the event may, thus, produce different audio signals for the different announcers along with the corresponding video signal. Another example in which audio signals produced for the same video signal may have different content may involve the transmission of a motion picture video with, not only the various different language versions of the audio stream, but also an audio stream containing commentary (e.g., a running commentary by a person, such as the director, producer, actor, etc. of the motion picture) or an audio stream containing audio for visually impaired people. All of these different audio signals or streams may be transmitted in the A/V stream to the video display devices 500 and/or the external audio-video device boxes 501, so that the end users can select which audio stream to listen to, as described below. (Other examples may be readily apparent of situations in which multiple audio signals or streams, corresponding to the same video signal or stream, may be produced with content that differs in a manner other than in the language spoken. Also, these different audio signals/streams may be provided in addition to the multiple-language audio signals/streams.)

In this manner, the audio-video signal transmission module 507 may produce a variety of A/V streams, some of which have multiple different audio signals/streams combined with a corresponding video signal/stream. These A/V streams are transmitted from the A/V source 502 to the video display devices 500 and/or the external audio-video device boxes 501. Downstream at the video device (i.e., the video display devices 500, the external audio-video device boxes 501 or the user devices 503), users can select which of the various audio streams to listen to, as described below.

Additional sources of audio streams may include radio broadcasts and/or online audio streaming services that produce audio content that are related to a given audio-video content program. Some of these audio streams may be produced by an A/V source 502 that is different and independent from the A/V source 502 that produces the video stream for the audio-video content program. For example, a first A/V source 502 may produce a televised audio-and-video version of an audio-video content program (e.g., of a live event), and a second A/V source 502 may independently produce a radio audio-only version of the event, with or without a time delay difference (described below) between the audio-and-video version and the audio-only version. Also, the additional audio streams from the second A/V source 502 may be linked to the audio-video content program. In some cases, for example, a link between the two streams may be established by simply including the additional audio streams in the A/V streams produced by the first A/V source 502. In other cases, the additional audio streams may be provided in separate (audio-only) A/V streams produced by the second A/V source 502. When provided as a separate A/V stream, a link may be established between a first A/V stream for the audio-video content program and a second A/V stream for the additional audio stream. The link may be in the form of data provided through a communication network (e.g., Internet, cellphone, etc.) to the video display devices 500, the external audio-video device boxes 501 and/or the user devices 503. The link data may enable these devices 500, 501 and/or 503 to present the additional audio stream as being available with and corresponding to the audio-video content program alongside any audio streams that accompanied the video stream within the first A/V stream. Alternatively, even if no link is established between the first A/V stream for the audio-video content program and the second A/V stream for the additional audio stream, the additional audio stream may be separately available through the devices 500, 501 and/or 503. The user may thus select the additional audio stream to listen to while watching the video stream, regardless of whether the additional audio stream is explicitly presented as corresponding to the audio-video content program.

In some embodiments, the video delay module 506 receives some or all of the video signals from the components for video signal generation 504 before these video signals are combined with the corresponding audio signals to form the A/V streams. In some embodiments, the video delay module 506 causes the video signals to be delayed relative to the corresponding audio signals by intentionally adding some additional time delay to the video signals, while the audio signals are generally processed through the various components of the A/V source 502 without an intentional addition of any time delay. However, in some embodiments, the audio signals may be intentionally delayed, e.g., to allow for on-the-fly censoring of profanity during a live presentation of an event. Nevertheless, the amount of time by which the audio signals may be intentionally delayed is typically smaller than the delay time of the video signal. The video signals (with or without intentionally added delay) are combined with the corresponding audio signals (one or more audio signals for each video signal and also with or without intentionally added delay) to form the A/V streams.

In some embodiments, the audio streams and the video streams may be synchronized at the servers 104, the video display devices 500, the external audio-video device boxes 501, and/or the user devices 503. The delay intentionally added to the video signals and/or the audio signals in some embodiments can assist the synchronization functions in these devices, since only the audio signal would need to be adjusted at these devices to match the delayed video signal in most situations. A variety of synchronization techniques are known and may be used in various embodiments described herein as appropriate. In some embodiments, for example, synchronization may involve a delay offset that is a function of the type and model of the device 500, 501 or 503 (e.g., model of television, set top box, smart phone and/or device software version). In some embodiments, synchronization may be aided by having some of the delay for the video signal and/or the audio signal done in one or more of the devices 104, 500, 501, and 503. In some embodiments, synchronization may be aided by having information embedded with the video streams and/or the audio streams (e.g., time stamps for A/V frames) by the A/V source 502, so that the devices 500, 501, and 503 can match the video stream data with the audio stream data. Other techniques for synchronization may also be used in appropriate embodiments.

If a given video signal has only one corresponding audio signal, then that video signal is delayed relative to that audio signal. If a video signal has multiple corresponding audio signals, then the video signal may be delayed relative to all of them or only some of them. In some embodiments, therefore, an A/V stream produced by the A/V source 502 may have a video signal with one or more audio signals relative to which the video signal is delayed and one or more other audio signals relative to which the video signal is not delayed. The audio signals relative to which the video signal is not delayed may have some additional delay intentionally added to them to synchronize these audio signals with the video signal. An audio signal that is synchronized with the video signal within the A/V source 502 may be considered to be a primary, or default, audio signal for the video signal. The primary/default audio signal may be used by downstream video devices that do not have audio syncing capabilities, such as legacy, conventional or prior art televisions and set top boxes. The audio signals that are not delayed or synced with the video signal at the A/V source 502 may be used by downstream video devices (e.g., 500 and/or 501) or user devices 503 that have audio syncing capabilities, such as the delay/synchronization functions at 244 (FIG. 20). In this manner, the A/V stream produced by the A/V source 502 may be compatible with legacy video devices, as well as with video devices incorporating some embodiments of the present invention. In some embodiments, every audio stream may come in pairs, with one already synchronized with the video stream, and one not synchronized with the video stream.

The amount of the delay that is intentionally added to the video signals may be anywhere from a fraction of a second up to several seconds in time. In general, the amount of the delay may be sufficient enough to enable the video display device 500, the external audio-video device boxes 501 and/or the user devices 503 to adequately synchronize the audio signals with the video signals, as described below. A longer delay time may generally allow more time for the devices 500, 501 and/or 503 to perform the synchronization, to assemble received audio data packets in their proper order, to request retransmission of lost audio data packets, and to produce the synchronized audio signal with a relatively high sound quality.

Additionally, since the audio signals and the video signals may take different paths through the components of the A/V source 502, there may be inherent delays added to both the audio signals and the video signals, and the inherent delays for the audio signals may be different from the inherent delays for the video signals. The additional delay that is intentionally added to the video signals, therefore, may be done with consideration for the difference in the inherent delays, such that the resulting video signals are delayed by a specific desired amount relative to the corresponding audio signals when the video and audio signals are combined to form the A/V streams produced by the A/V source 502.

The video display devices 500 may be televisions, computer monitors, all-in-one computers or other appropriate video or A/V display devices that generally receive the A/V streams from the A/V sources 502 or the external audio-video device boxes 501 or both. In some embodiments, the external audio-video device boxes 501 may be considered optional, since some of the A/V sources 502 or the video display devices 500 do not require an intermediary device, so the video display devices 500 may receive the A/V streams directly from the A/V sources 502. In some embodiments, the A/V sources 502 may be considered optional, since some types of the external audio-video device boxes 501 (e.g., VCRs, DVD players, etc.) may serve as A/V sources and internally generate A/V streams for transmission to the video display devices 500. Additionally, as will be readily apparent from the description herein even if not explicitly stated, some features or combinations of features for the video display devices 500 may be more appropriate for use in a commercial environment, such as that described with reference to FIG. 1; whereas, other features or combinations of features may be more appropriate for use in a home or private environment.

In some embodiments, the video display devices 500 may include some or all of the functions of the servers 104 (server functions 508) and optional wireless communication functions 509 (e.g., including transceivers for WiFi, Bluetooth, etc.). In an embodiment in which the video display devices 500 are used in an environment 100 similar to that described above for FIG. 1, therefore, the servers 104 may be unnecessary or optional. Instead of transmitting its available audio streams to the servers 104 for subsequent transmission to the user devices 503, each of the video display devices 500 handle communications with the user devices 503 directly through the wireless communication functions 509. Alternatively, if the video display device 500 does not have the optional wireless communication functions 509, then communication with the user devices 503 may be through the one or more wireless access points 228, as described above.

In this manner, the video display devices 500, rather than the servers 104, may indicate which audio streams are available and receive the requests to access the available audio streams. In response to the access requests, the video display devices 500 transmit the requested audio streams to the requested destination (e.g., the user devices 503) without passing the audio stream through the servers 104. Additionally, each video display device 500 can receive requests from, and transmit requested audio streams to, multiple destinations, with each destination receiving a different audio stream if desired by the users.

In various embodiments, each video display device 500 presents a video stream on a display screen 510 for viewing by users, depending on a selection made of the external audio-video device boxes 501 and the various A/V sources 502 and the various audio-video content programs or TV channels received therefrom. The video display device 500 can then generate a list of available audio streams (e.g., the audio streams that correspond to or are linked with the video stream), provide the list to any device (e.g., that accesses or logs into the video display device 500) and receive a request from the device to access one of the available audio streams.

For example, a user device 503 may login to the video display device 500. The video display device 500 may then indicate which audio streams are available by sending the list to the user device 503 and receive back a request from the user device 503 to access one of the available audio streams. The video display device 500 may then transmit the requested audio stream to the user device 503 for presentation to the user through a listening device (e.g., 106, FIG. 1) included in or connected (wired or wirelessly) to the user device 503. Alternatively, the user device 503 may direct the video display device 500 to transmit the selected audio stream to a different destination, such as a listening device included in or connected (wired or wirelessly) to the video display device 500, a different user device 503 or other appropriate device. For example, the video display device 500 may have a Bluetooth™ transceiver for communicating with Bluetooth audio headsets. In this case, it would be an unnecessary complication for the audio stream to be transmitted through the user device 503 to a Bluetooth headset, since the video display device 500 could be paired directly with the Bluetooth headset, and the user device 503 could direct the video display device 500 to transmit the audio stream directly to the Bluetooth headset.

Alternatively, the user may interact with an on-screen menu on the display screen 510 through a remote control device for the video display device 500. (The remote control device may be any appropriate type of device, such as a user device 503 or a conventional remote control that is typically used to select channels, A/V sources 502, audio volume, and other options on a television, among other possible devices.) The video display device 500 may then indicate which audio streams are available by presenting the list on the display screen 510. With the remote control, the user may select the desired destination device (e.g., a user device 503, a Bluetooth headset, a wired headset, another listening device, etc.) and the desired audio stream to be transmitted to the destination device.

If a particular video display device 500 is presenting an audio-video content program that has only one corresponding audio stream, then the video display device 500 may begin transmitting that audio stream to the user device 503, or other destination device, immediately upon receiving the access request. On the other hand, if the video display device 500 is presenting an audio-video content program that has multiple corresponding audio streams, then the video display device 500 may transmit data to the user device 503 for the user device 503 to present a menu with which the user may select the desired audio stream. The menu may show the available audio streams for the audio-video content program, along with a short description of each audio stream, e.g., language, announcer, commentary, visually impaired, related radio broadcast, etc. Upon receiving a selection for the desired audio stream, the video display device 500 may begin transmitting that audio stream to the user device 503.

In some embodiments with multiple video display devices 500 in a single environment (e.g., 100), one or a subset of the video display devices 500 may aggregate the audio stream menu data and the access request functions for a combination of all of the video display devices 500 and all of the audio streams available therefrom. In this manner, some of the traffic on the local network between the video display devices 500 and the user devices 503 is consolidated to a single point of access. In this case, the user devices 503 may be redirected to one of the other video display devices 500 (after the audio stream selection has been made) for the other video display device 500 to handle the transmitting of the audio stream to the user devices 503. In some embodiments, all of the video display devices 500 may be capable of the aggregated data and access request functions, but only a selected subset may have these functions enabled or turned on. Alternatively, a scaled-down version of the servers 104 may perform these functions. As another alternative, one of the video display devices 500 may perform the server functions 508 for the display devices 101 that do not have the server functions.

Additionally, some of the above described functions of the servers 104, particularly in an embodiment similar to that described above with respect to FIG. 1, may be consolidated into only one, or a subset, of the video display devices 500 present in the environment 100. The consolidated functions may include the sign up, login, general action selection, display device selection, settings selection, and food and drink ordering functions described above with respect to FIGS. 5-8 and 13-18, among other functions. In some embodiments, all of the video display devices 500 may be capable of the consolidated functions, but only a selected subset may have the consolidated functions enabled or turned on. Alternatively, a scaled-down version of the servers 104 may perform the consolidated functions.

The external audio-video device boxes 501 may have functions similar to those of the optional receivers 227. Additionally, the external audio-video device boxes 501 may be any appropriate type of audio-video set top box or dongle device, such as an A/V intermediary device (e.g., a cable TV converter box, a satellite TV converter box, a channel selector box, a TV descrambler box, an A/V splitter, a digital video recorder (DVR) device, a TiVo™ device), a video player (e.g., VCR, DVD player, Blue-ray player, DVR, etc.), a game console, a networking device (e.g., for Internet or communication network based video services), a Google Chromecast™ device, an Apple TV™ device, etc. The external audio-video device boxes 501, thus, may be any type of device that provides one or more A/V streams that are either externally received or internally generated by the external audio-video device boxes 501. Typically, the external audio-video device boxes 501 are internal and local to the environment 100, along with the video display devices 500. Additionally, as will be readily apparent from the description herein even if not explicitly stated, some features or combinations of features for the external audio-video device boxes 501 may be more appropriate for use in a commercial environment, such as that described with reference to FIG. 1; whereas, other features or combinations of features may be more appropriate for use in a home or private environment.

In some embodiments in which the external audio-video device box 501 is connected to the video display device 500 that has the server functions 508, the external audio-video device box 501 may support the video display device 500 in the performance of these functions. In particular, when the external audio-video device box 501 receives the A/V streams from the A/V sources 502, the external audio-video device box 501 may transmit all of the available audio streams to the video display device 500.

Additionally, the DVD standards allow for multiple audio tracks (e.g., for multiple languages, commentary, etc.) to accompany an audio-video content program on a DVD disk. When a user watches the audio-video content program, an on-screen menu from the DVD device enables the user to select which audio track to listen to. The conventional DVD device then sends only the selected audio track to the video display device. In contrast, some embodiments herein enable the external audio-video device box 501, if it includes DVD (or other video player) capabilities, to transmit all of the available audio tracks to the video display device 500 when the audio-video content program is played. The video display device 500 may thus treat the multiple audio tracks in the same manner as it treats the multiple audio streams, i.e., it may indicate that multiple audio streams are available for the DVD audio-video content program, and the user may select one to listen to in any of the manners described herein. An example implementation in which the multiple audio tracks may be transmitted from the external audio-video device box 501 (as a DVD/video player) to the video display device 500 may involve the use of an HDMI cable. The HDMI standards allow for multiple audio streams to be provided simultaneously through the cables. This feature may, thus, be enabled in the external audio-video device box 501 and the video display devices 500. Other embodiments for enabling this feature between the external audio-video device box 501 (as a DVD/video player) and the video display device 500 may also be used.

Alternatively, in some embodiments, in addition to the features described above for the optional receivers 227, the external audio-video device boxes 501 may include some or all of the functions of the servers 104 (server functions 511) and optional wireless communication functions 512 (e.g., including transceivers for WiFi, Bluetooth, etc.). In this case, the server functions 508 in the video display device 500 may be unnecessary or optional. Additionally, in an embodiment in which the external audio-video device boxes 501 are used in an environment 100 similar to that described above for FIG. 1, the servers 104 may be unnecessary or optional.

In these embodiments, instead of transmitting its available audio streams to the servers 104 or the video display devices 500 for subsequent transmission to the user devices 503, each of the external audio-video device boxes 501 can handle communications with the user devices 503 or listening devices either directly (e.g., through the wireless communication functions 512) or through the one or more wireless access points 228, as described above.

In this manner, the external audio-video device boxes 501, rather than the servers 104 or the video display devices 500, may indicate which audio streams are available and receive the requests to access the available audio streams. In response to the access requests, the external audio-video device boxes 501 transmit the requested audio streams to the requested destination (e.g., the user devices 503) without passing the audio stream through the servers 104 or the video display devices 500. Additionally, each external audio-video device box 501 can receive requests from, and transmit requested audio streams to, multiple destinations, with each destination receiving a different audio stream if desired by the users.

In various embodiments, the external audio-video device box 501 transmits a video stream to the video display device 500 for presentation on the display screen 510 for viewing by users, depending on a selection made of the various A/V sources 502 and the various audio-video content programs or TV channels received therefrom. The external audio-video device box 501 can then generate a list of available audio streams (e.g., the audio streams that correspond to or are linked with the video stream), provide the list to any device (e.g., that accesses or logs into the external audio-video device box 501) and receive a request from the device to access one of the available audio streams.

For example, a user device 503 may login to the external audio-video device box 501. The external audio-video device box 501 may then indicate which audio streams are available by sending the list to the user device 503 and receive back a request from the user device 503 to access one of the available audio streams. The external audio-video device box 501 may then transmit the requested audio stream to the user device 503 for presentation to the user through the listening device (e.g., 106, FIG. 1) included in or connected (wired or wirelessly) to the user device 503. Alternatively, the user device 503 may direct the external audio-video device box 501 to transmit the selected audio stream to a different destination, such as a listening device included in or connected (wired or wirelessly) to the external audio-video device box 501, a different user device 503, the video display device 500 or other appropriate device. For example, the external audio-video device box 501 may have a Bluetooth™ transceiver for communicating with Bluetooth audio headsets. In this case, it would be an unnecessary complication for the audio stream to be transmitted through the user device 503 to a Bluetooth headset, since the external audio-video device box 501 could be paired directly with the Bluetooth headset, and the user device 503 could direct the external audio-video device box 501 to transmit the audio stream directly to the Bluetooth headset.

Alternatively, the user may interact with an on-screen menu on the display screen 510 of the video display device 500 through a remote control device for the external audio-video device box 501. (The remote control device may be any appropriate type of device, such as a user device 503 or a conventional remote control that is typically used to select channels, A/V sources 502, audio volume, and other options on a television, among other possible devices.) The external audio-video device box 501 may then indicate which audio streams are available by presenting the list on the display screen 510. With the remote control, the user may select the desired destination device (e.g., a user device 503, a Bluetooth headset, a wired headset, another listening device, etc.) and the desired audio stream to be transmitted to the destination device.

If the external audio-video device box 501 is presenting an audio-video content program that has only one corresponding audio stream, then the external audio-video device box 501 may begin transmitting that audio stream to the user device 503, or other destination device, immediately upon receiving the access request. On the other hand, if the external audio-video device box 501 is presenting an audio-video content program that has multiple corresponding audio streams, then the external audio-video device box 501 may transmit data to the user device 503 for the user device 503 to present a menu with which the user may select the desired audio stream. The menu may show the available audio streams for the audio-video content program, along with a short description of each audio stream, e.g., language, announcer, commentary, visually impaired, related radio broadcast, etc. Upon receiving a selection for the desired audio stream, the external audio-video device box 501 may begin transmitting that audio stream to the user device 503.

In some embodiments with multiple external audio-video device boxes 501 and multiple video display devices 500 (which may also include some video display devices 500 that have the server functions 508, i.e., server-enhanced video display devices 500, and some that do not) in a single environment (e.g., 100), one or a subset of the external audio-video device boxes 501 may aggregate the audio stream menu data and the access request functions for a combination of all of the external audio-video device boxes 501, the server-enhanced video display devices 500 and all of the audio streams available therefrom. In this manner, some of the traffic on the local network between the external audio-video device boxes 501, the server-enhanced video display devices 500 and the user devices 503 is consolidated to a single point of access. In this case, the user devices 503 may be redirected to one of the other external audio-video device boxes 501 or one of the server-enhanced video display devices 500 (after the audio stream selection has been made) for the other external audio-video device box 501 or the video display device 500 to handle the transmitting of the audio stream to the user devices 503. In some embodiments, all of the external audio-video device boxes 501 and server-enhanced video display devices 500 may be capable of the aggregated data and access request functions, but only a selected subset may have these functions enabled or turned on. Alternatively, a scaled-down version of the servers 104 may perform these functions. As another alternative, one of the external audio-video device boxes 501 may perform the server functions 508 for the display devices 101 that do not have the server functions.

Additionally, some of the above described functions of the servers 104, particularly in embodiments similar to those described above with respect to FIG. 1, may be consolidated into only one, or a subset, of the external audio-video device boxes 501 and server-enhanced video display devices 500 present in the environment 100. The consolidated functions may include the sign up, login, general action selection, display device selection, settings selection, and food and drink ordering functions described above with respect to FIGS. 5-8 and 13-18, among other functions. In some embodiments, all of the external audio-video device boxes 501 and server-enhanced video display devices 500 may be capable of the consolidated functions, but only a selected subset may have the consolidated functions enabled or turned on. Alternatively, a scaled-down version of the servers 104 may perform the consolidated functions.

In some embodiments, the user devices 503 may acquire network or Internet access through the one or more wireless access points 228 or a cellphone network. Therefore, for A/V content streaming services (such as Netflix, Hulu, Amazon Prime, etc.), the user device 503, the video display devices 500 and the external audio-video device boxes 501 can each access the A/V content independently directly from the A/V content streaming services through different transmission paths with the Internet. In this case, the requested audio stream does not need to go through the video display devices 500 or the external audio-video device boxes 501. Instead, the video display devices 500 and the external audio-video device boxes 501 may redirect the audio stream access request to the A/V content streaming service, or the user device 503 may place the access request directly with the A/V content streaming service. Then the audio stream may be transmitted by the A/V content streaming service through the Internet and/or the cellphone network to the user device 503. If the video stream is sufficiently delayed, as discussed above, then any transmission delay differences through the different transmission paths for the audio stream and the video stream can be adequately accounted for with audio syncing functions at the user device 503.

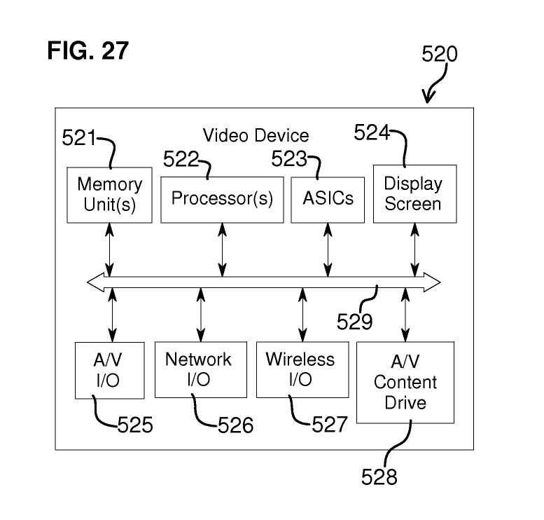

FIG. 27 shows a simplified schematic diagram for an example video device 520, e.g., for the video display devices 500 and/or the external audio-video device boxes 501, in accordance with some embodiments. The example video device 520 generally includes memory units 521, processors 522, ASICs 523, a display screen 524, audio-video I/O ports 525, network I/O ports 526, wireless I/O ports 527, an audio-video content drive 528, and a communication bus 529. Some of these components may be optional, combined together and/or divided into multiple additional components, depending on the various embodiments. For example, the external audio-video device boxes 501 may not need to have the display screen 524. Also, the audio-video content drive 528 and the memory units 521 may overlap or be completely combined together. Other variations will be apparent.

In general, the memory units 521 represent any appropriate non-transitory computer memory storage media devices or combinations thereof, e.g., RAM, ROM, Flash drives, hard drives, solid state memory, removable memory, etc. The memory units 521 store the programs and data used to perform some of the functions described herein for the video display devices 500 and/or the external audio-video device boxes 501. The memory units 521 receive and transmit the programs and data from and to other components of the video device 520. For example, many of the server functions 508 and 511 may be incorporated in computer programs and use data stored in the memory units 521.

The processors 522 generally represent various types of central processing units, graphics processing units, microprocessors or combinations thereof. The processors 522 perform some of the functions and control some other functions of the video device 520 in accordance with the programs and data stored in and received from the memory units 521. The processors 522, thus, execute programmed instructions and operate on data to perform these functions. The processors 522 also generally communicate with the other components 521 and 523-529 to perform these functions.

The ASICs (application specific integrated circuits) 523 generally represent various components having digital and/or analog circuits that perform some of the functions and control some other functions of the video device 520 in accordance with their circuitry design. In some cases, functions not performed by, or not suitable for performance by, the processors 522 may be performed by the ASICs 523. For example, some functions involved with handling the video streams, the audio streams, communications, and graphics functions, among others, for the video display devices 500 and/or the external audio-video device boxes 501 may be made faster or more efficient in an ASIC design, than in a computer program executed by a processor.

The display screen 524 (e.g., the display screen 510) generally represents any appropriate display device, such as those used in televisions and with computers. The video streams, user interfaces, and the menus described herein may be displayed on the display screen 524 for viewing by the users. Embodiments for the video display devices 500 may include the display screen 524, but embodiments for the external audio-video device boxes 501 may not need it, except possibly for a small control display on which some setup menus may be presented.

The audio-video I/O (input/output) ports 525 generally represent any appropriate I/O port circuitry and connectors that may be used for audio signals and/or video signals, such as HDMI (High-Definition Multimedia Interface) ports, Digital Visual Interface (DVI) ports, RCA connectors, composite video interfaces, component video interfaces, audio jacks, Video Graphics Array (VGA) ports, Separate Video (S-Video) ports, HDBaseT ports, IEEE 1394 “FireWire” ports, etc. The external audio-video device boxes 501 may include the audio-video I/O ports 525 as inputs from the A/V sources 502 and outputs to the video display devices 500 for the audio signals/streams and the video signals/streams in accordance with some embodiments. The video display devices 500 may include the audio-video I/O ports 525 as inputs from the A/V sources 502 and/or the external audio-video device boxes 501 for the audio signals/streams and the video signals/streams and possibly as outputs to the user devices 503 and/or the listening devices 106 for the audio signals/streams in accordance with some embodiments.

The network I/O ports 526 generally represent any appropriate circuitry and connectors for communication networks, such as Ethernet ports, USB (Universal Serial Bus) ports, IEEE 1394 “FireWire” ports, etc. Internet, LAN, and other network communications may be sent and received through the network I/O ports 526. In some embodiments, the audio signals/streams and the video signals/streams may be received by the video display devices 500 and/or the external audio-video device boxes 501 through the network I/O ports 526. Additional communications between the video device 520 and the A/V sources 502, the user devices 503, and/or the listening devices 106 may also potentially be made through the network I/O ports 526.

The wireless I/O ports 527 generally represent any appropriate circuitry and connectors for wireless communication devices, such as WiFi, Bluetooth, cellphone network, etc., that may be used for the wireless communication functions 509 or 512. Any communications with the video devices 520 that may be made through the network I/O ports 526 may also potentially be made through the wireless I/O ports 527. Additionally, the communications described herein between the video display devices 500, the external audio-video device boxes 501, the user devices 503 and the listening devices 106 may be more conveniently made through the wireless I/O ports 527.

The audio-video content drive 528 generally represents one or more mass storage devices with removable or non-removable storage media, such as hard drives, flash drives, DVD drives, CD drives, etc. The video content drive 528 may be in addition to, or combined with, the memory units 521. In some embodiments, e.g., when the external audio-video device box 501 is a DVD player or other video player, the audio-video content drive 528 stores the data for the audio-video content programs.

The communication bus 529 generally represents various circuit components for one or more of a variety of internal communication subsystems. The various components 521-528 generally communicate with each other through these internal communication subsystems. In some embodiments, not all of the components 521-528 use the same internal communication subsystems.

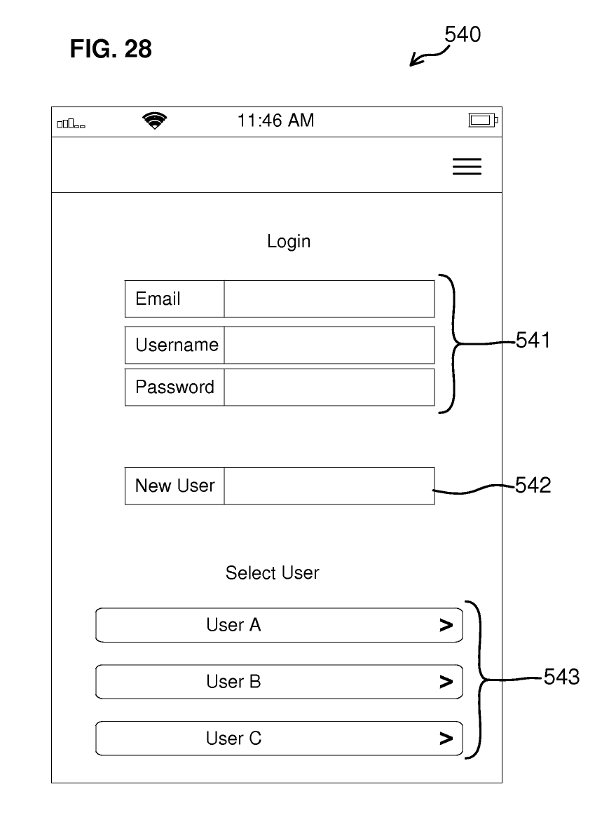

FIGS. 28-31 show various simplified examples of views of a user interface or on-screen menus (“menus”) for one or more applications for some of the functions of the video display devices 500, the external audio-video device boxes 501, and the user devices 503 in accordance with some embodiments. The applications may enable cooperative communication between each of these devices 500, 501 and/or 503 and the A/V sources 502 to enable some of the functions described above. The menus, with menu selection options (e.g., icons, buttons, fill-in boxes, etc.), may be presented on a display screen of the user device 503 or the display screen 510 or 524 of the video display device 500. In embodiments for the user device 503, an application running on the user device 503 may generate the menus, or an application running on the video display devices 500 or the external audio-video device boxes 501 may generate and transmit the menus to the user device 503. In embodiments for the display screens 510 or 524, an application running on the video display devices 500 or the external audio-video device boxes 501 may generate the menus. The user may interact with the menus via the user device 503 or a remote control, as described above. If the user device 503 or the video display device 500 has a touchscreen, then the user may make a selection by pressing an icon or a proper location on the screen. Otherwise, the user may click the icon or location with a pointing device or press a button on a keypad to make a selection in the menus. Additionally, other menus, menu selection options or combinations of menus may be used in other embodiments to achieve generally similar results.

For example, an optional login screen 540, as shown in FIG. 28, may enable a user to login to the video display devices 500 or the external audio-video device boxes 501. For embodiments similar to those described above for FIG. 1, however, a separate login in addition to that described above for FIGS. 4-6 may be unnecessary. However, for simpler embodiments, e.g., for a home environment, the example login screen 540 may be used to allow only desired users to access the video display devices 500 or the external audio-video device boxes 501. Thus, for initial login, users may be requested to enter typical login data (e.g., email address, username, and password) at input boxes 541, which the user can fill in. Alternatively, for an initial login using the remote control with the video display device 500 or the external audio-video device boxes 501, users may create a new user profile by simply entering their name in a new user input box 542, which the user can fill in. Then for subsequent logins using the remote control, the users may simply identify themselves by selecting a user identifying button icon 543. For an initial login through the user device 503, the login screen 540 may be used to establish a link between the user device 503 and the video display devices 500 or the external audio-video device boxes 501. For subsequent logins through the user device 503, the login screen 540 may be skipped, since the user device 503 can then potentially automatically handle the login.

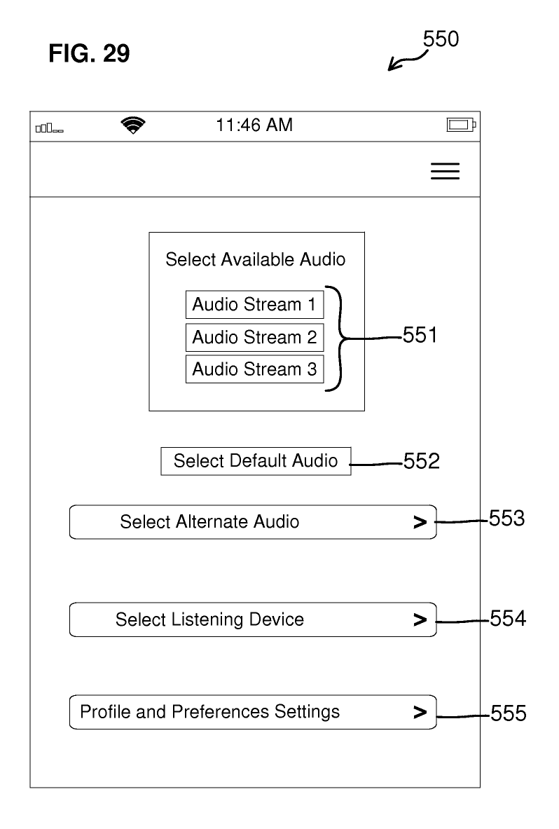

After logging in, an audio selection screen 550, as shown in FIG. 29, may be used to select the audio stream the user wants to listen to. Presumably, the video display device 500 or the external audio-video device box 501 has already been set to present a desired TV channel or audio-video content program on the display screen 510 to present a video stream. Therefore, the audio selection screen 550 may present the descriptive list (generated as described above) of available audio streams as audio selection button icons 551, with which the user can select the desired audio stream to accompany the presented video stream.

In some embodiments, an optional default audio stream selection button icon 552 may be used to select a primary, or default, audio signal for the presented video stream. This option may be used, for example, if the user does not have a particular preference for an audio stream. Additionally, the primary/default audio signal may be one that is already sufficiently synced with the presented video stream, as mentioned above.

In some embodiments, an optional alternate audio stream selection button icon 553 may be used to select an audio stream that may or may not already be linked to the presented video stream, such as the radio broadcasts and/or online audio streaming, as described above. An additional audio stream that is already linked to the presented video stream may be shown in another menu as alternative audio selection button icons instead of, or in addition to, the audio selection button icons 551. Alternatively, all potentially available audio streams, regardless of whether they are linked to the presented video stream in any manner, may be shown in another menu in a list through which the user may scroll to make a selection.

In some embodiments, a listening device selection button icon 554, in this or another selection screen, may allow the user to select the listening device 106 with which to listen to the selected audio stream. Selecting icon 554, therefore, may take the user to another menu that lists all available listening devices 106, so the user may select which listening device 106 for the video display device 500 or the external audio-video device box 501 to transmit the audio stream to. Whether the audio selection screen 550 is presented through the video display device 500 or the user device 503, this feature may be particularly useful in embodiments in which the user desires to use a listening device 106 that does not involve, or that bypasses, the user device 503, e.g., a Bluetooth headset wirelessly connected directly to the video display device 500 or the external audio-video device box 501, as described above. For embodiments that involve the user device 503, and the user desires to use a listening device 106 included in or connected to the user device 503, then selection of the listening device 106 may optionally be done with this feature or other built-in features of the user device 503.

For embodiments that do not include a login for the users, but there are multiple users who each want to listen with different listening devices 106, the selection (of the audio stream and the listening device 106 or the user device 503 to which the video display device 500 or the external audio-video device box 501 is to transmit the audio stream) may be repeated for each listening device 106 or user device 503. In this manner, audio streams are simply “paired” with the listening devices 106 or the user devices 503 without a specific login to the video display device 500 or the external audio-video device box 501. A subsequent pairing of an audio stream and a listening device 106 or user device 503, however, should not cancel out a previous pairing. Instead, each pairing may be manually canceled by the user or automatically canceled upon turning off one of the devices (e.g., 106, 500, 501 or 503).

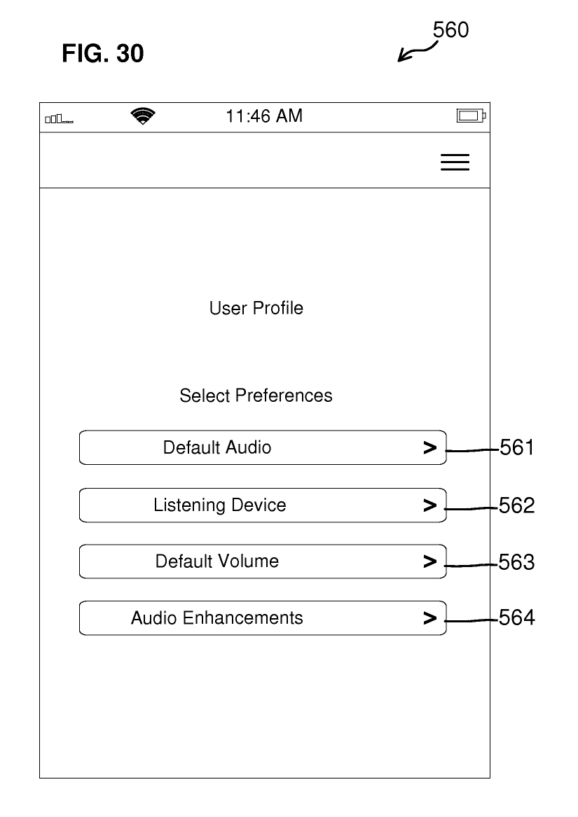

In some embodiments, a profile and preferences settings selection button icon 555, in this or another selection screen, may allow the user to store preferred, or default, selections or settings in the user device 503, the video display device 500 or the external audio-video device box 501. Selecting the profile and preferences settings selection button icon 555, thus, may cause the user device 503, the video display device 500 or the external audio-video device box 501 to present a user profile screen 560, as shown in FIG. 30. The user profile screen 560 may allow each user to set preferences for some features that can be stored in the user device 503, the video display device 500 or the external audio-video device box 501, so that the user can begin listening to the desired audio stream more quickly after logging in to the video display device 500 or the external audio-video device box 501. The various preferences are settable per user, so that the audio streams can be specifically tailored to the best or preferred settings for each user.

For example, a default audio stream selection button icon 561 may be used to set a desired default audio stream for some TV channels or audio-video content programs. Selecting the default audio stream selection button icon 561 may, thus, cause another menu or series of menus to be presented, so the user can set the desired default audio stream for one or more of the TV channels or audio-video content programs. Thus, when the user logs in, the video display device 500 or the external audio-video device box 501 can immediately begin transmitting the desired default audio stream for those TV channels or audio-video content programs.

Additionally, a default listening device selection button icon 562 may be used to set a desired default listening device 106. Selecting the default listening device selection button icon 562 may, thus, cause another menu or series of menus to be presented, so the user can select one of the listening devices 106 included in or connected to the user device 503, the video display device 500 or the external audio-video device box 501. Thus, when the user logs in and selects an audio stream, the video display device 500 or the external audio-video device box 501 can immediately begin transmitting the selected audio stream to the default listening device 106.

Additionally, a default volume selection button icon 563 may be used to set a desired default volume at which the audio streams are presented. Selecting the default volume selection button icon 563 may, thus, cause another menu to be presented with which the default volume may be set, e.g., the volume slider bar 162 (FIGS. 8 and 11) may be provided for setting the default volume. Thus, when the user logs in and selects an audio stream, the video display device 500 or the external audio-video device box 501 can immediately begin transmitting the selected audio stream at the default volume or the user device 503 may automatically set its volume level to the default volume.

Additionally, a default audio enhancements selection button icon 564 may be used to set certain default audio enhancements with which the audio streams are presented. Such audio enhancements, for example, may include the audio spectrum for the audio streams. Selecting the default audio enhancements selection button icon 564 may, thus, cause the example equalizer selection screen 170 to be presented for the user for the user to set volume levels for different frequencies of the audio stream, as described above. For example, in many motion pictures, most speech is within a particular range of audio frequencies (e.g., 400 to 7000 Hz), while explosions and machine sounds are generally at lower frequencies, and other extraneous sounds may be at higher frequencies. Therefore, the user may perform “dialog enhancement” with the equalizer by increasing the audio volume for the speech range and decreasing the volume for other ranges in order to enjoy the sound better. Additionally, hearing-impaired users may shape the audio spectrum for their hearing needs. In fact, with this feature, it may be possible to give a user a hearing test, so that the audio spectrum can be tailored (equalized) for that user individually to give the best listening experience. Thus, when the user logs in and selects an audio stream, the video display device 500 or the external audio-video device box 501 can transmit, or the user device 503 can present, the selected audio stream with the proper audio enhancements.

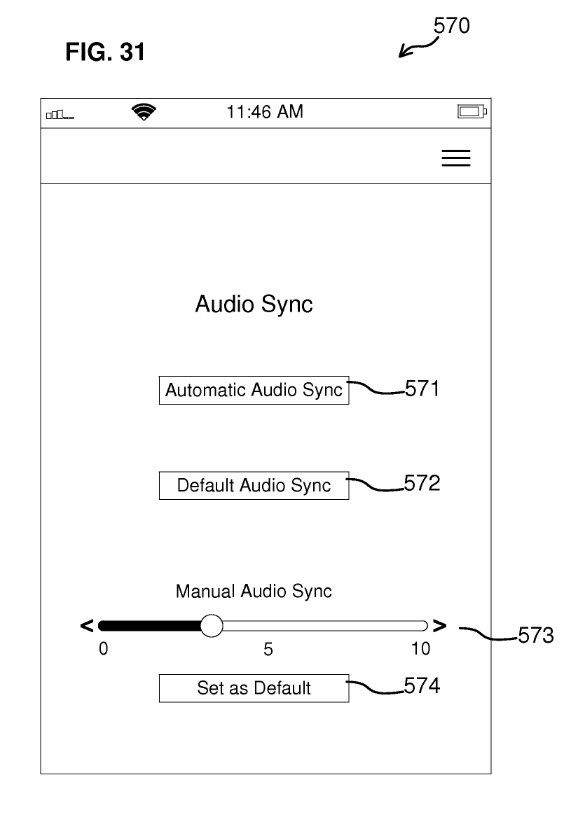

An example audio sync screen 570, as shown in FIG. 31, may be used to adjust the synchronization between the selected audio stream and the presented video stream, as described above, e.g., to delay the audio stream to match the video stream. An automatic audio sync selection button icon 571 may be selected by the user for the user device 503, the video display device 500 or the external audio-video device box 501 to automatically sync the audio stream with the video stream, e.g., if the delay difference between the audio stream and the video stream is known, can be estimated or can be determined based on prior use of the A/V sources 502 or the A/V streams. Alternatively, a default audio sync selection button icon 572 may be selected by the user for the device 500, 501 or 503 to set the synchronization, e.g., delay the audio stream, to a default value. The default value may be built-in to applications in the device 500, 501 or 503, or the default value may be manually settable by the user or automatically settable by the device 500, 501 or 503. Additionally, the default value may have one value for all audio streams or individual values set for each A/V source 502, A/V stream, TV channel or audio-video content program. Alternatively, a manual audio sync slider bar 573 may be used by the user to set the sync for the audio stream while the user watches the video stream, so the user can readily see and hear whether the sync is proper. The manual audio sync slider bar 573 may allow for adjusting the audio stream forward or backward on a continuous scale or in discrete steps of appropriate length. When the sync is appropriately set, a set as default selection button icon 574 may be selected to use the current synchronization to set the default value.

Although embodiments of the present invention have been discussed primarily with respect to specific embodiments thereof, other variations are possible. Various configurations of the described system may be used in place of, or in addition to, the configurations presented herein. For example, additional components may be included in circuits where appropriate. As another example, configurations were described with general reference to certain types and combinations of circuit components, but other types and/or combinations of circuit components could be used in addition to or in the place of those described.

Those skilled in the art will appreciate that the foregoing description is by way of example only, and is not intended to limit the present invention. Nothing in the disclosure should indicate that the present invention is limited to systems that have the specific type of devices shown and described. Nothing in the disclosure should indicate that the present invention is limited to systems that require a particular form of semiconductor processing or integrated circuits. In general, any diagrams presented are only intended to indicate one possible configuration, and many variations are possible. Those skilled in the art will also appreciate that methods and systems consistent with the present invention are suitable for use in a wide range of applications.

While the specification has been described in detail with respect to specific embodiments of the present invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the spirit and scope of the present invention, which is more particularly set forth in the appended claims.

1. A method comprising:
a server receiving an audio stream that is one of a plurality of audio streams received by the server, the plurality of audio streams corresponding to a plurality of video streams available for simultaneous viewing on a plurality of video display devices within an environment;
the server indicating that the audio stream is available for access;
the server receiving a request to access the audio stream from a personal user device that is within the environment, the personal user device running an application, the personal user device being physically distinct from the plurality of video display devices, and the personal user device including or being connected to a listening device that is distinct from the plurality of video display devices; and
the server transmitting the audio stream to the personal user device;
and wherein the application running on the personal user device presents the audio stream through the listening device so that a user is capable of listening to the audio stream through the personal user device while watching the plurality of video streams through the plurality of video display devices.

2. The method of claim 1, wherein:
the audio stream corresponds to one of the plurality of video streams; and
one of the plurality of video display devices receives the one of the plurality of video streams from an audio-video source in a delayed state relative to the audio stream when the audio stream is received by the server.

3. The method of claim 2, further comprising:
the server transmitting the audio stream to the personal user device for the personal user device to synchronize the audio stream with the one of the plurality of video streams.

4. The method of claim 2, further comprising:
prior to transmitting the audio stream to the personal user device, the server synchronizing the audio stream with the one of the plurality of video streams.

5. The method of claim 1, wherein:
the server is located within a housing, and integrated into an electronic circuitry, of at least one of the plurality of video display devices.

6. The method of claim 1, wherein:
the server is located within a housing, and integrated into an electronic circuitry, of an audio-video set top box or dongle device connected to at least one of the video display devices.

7. A method comprising:
a video display device receiving a plurality of audio streams, the plurality of audio streams corresponding to at least one video stream presented for viewing on the video display device within an environment;
the video display device indicating that the plurality of audio streams are available for access;
the video display device receiving a request to access a selected one of the plurality of audio streams; and
the video display device transmitting the selected one of the plurality of audio streams to a listening device that is physically distinct from the video display device;
wherein a user is capable of listening to the selected one of the plurality of audio streams through the listening device while watching the at least one video stream through the video display device.

8. The method of claim 7, further comprising:
the video display device receiving the at least one video stream from an audio-video source in a delayed state relative to the selected one of the plurality of audio streams.

9. The method of claim 8, further comprising:
the video display device transmitting the selected one of the plurality of audio streams to the listening device through a personal user device for the personal user device to synchronize the selected one of the plurality of audio streams with the at least one video stream, the personal user device being physically distinct from the video display device.

10. The method of claim 8, further comprising:
prior to transmitting the selected one of the plurality of audio streams to the listening device, the video display device synchronizing the selected one of the plurality of audio streams with the at least one video stream.

11. The method of claim 7, further comprising:
the video display device receiving the request from a personal user device that is within the environment, the personal user device running an application, and the personal user device being physically distinct from the video display device.

12. The method of claim 11, wherein:
the personal user device includes or is connected to the listening device; and
the method further comprises transmitting the selected one of the plurality of audio streams to the listening device through the personal user device.

13. The method of claim 11, further comprising:
the video display device transmitting the selected one of the plurality of audio streams to the personal user device through a wireless access point that is separate and physically distinct from the video display device.

14. The method of claim 11, further comprising:
the video display device transmitting the selected one of the plurality of audio streams to the personal user device through a wireless access point located within a housing, and integrated into an electronic circuitry, of the video display device.

15. The method of claim 7, further comprising:
the video display device wirelessly transmitting the selected one of the plurality of audio streams directly to the listening device through a wireless transmitter that is located within a housing, and integrated into an electronic circuitry, of the video display device.

16. The method of claim 7, wherein:
the video display device is a television.

17. The method of claim 7, wherein:
the video display device is one of a plurality of video display devices within the environment;
the at least one video stream is one of a plurality of video streams;
each of the plurality of video display devices presents one of the plurality of video streams simultaneously within the environment; and
each of the plurality of video display devices performs the method with one or more audio streams that correspond to the one of the plurality of video streams presented by that video display device, such that a combined plurality of audio streams are available to be transmitted to the listening device from the plurality of video display devices.

18. The method of claim 17, wherein:
the video display device aggregates data for the combined plurality of audio streams; and
the video display device indicates that each of the combined plurality of audio streams is available for access.

19. The method of claim 17, further comprising:
the plurality of video display devices transmitting selected ones of the combined plurality of audio streams to a plurality of the listening devices through a wireless access point located within the environment.

20. The method of claim 17, further comprising:
the plurality of video display devices transmitting selected ones of the combined plurality of audio streams to a plurality of the listening devices through a plurality of wireless access points, each wireless access point being located within a housing, and integrated into an electronic circuitry, of a corresponding one of the plurality of video display devices.

21. The method of claim 7, further comprising:
the video display device pausing the transmitting of the selected one of the plurality of audio streams at a pause point; and
the video display device resuming the transmitting of the selected one of the plurality of audio streams at or near the pause point.

22. The method of claim 7, wherein:
the plurality of audio streams correspond to a single one of the at least one video stream; and
the plurality of audio streams and the single one of the at least one video stream are provided by a single audio-video source.

23. The method of claim 22, wherein:
the plurality of audio streams are multiple language audio streams.

24. The method of claim 22, wherein:
the plurality of audio streams are in a single language and provide different audio content for the single one of the at least one video stream.

25. The method of claim 7, wherein:
the plurality of audio streams are related to a single one of the at least one video stream; and
the plurality of audio streams and the single one of the at least one video stream are provided by at least two different audio-video sources.

26. The method of claim 7, further comprising:
enhancing the selected one of the plurality of audio streams according to audio enhancement preferences selected by the user.

27. The method of claim 7, further comprising:
the video display device receiving the plurality of audio streams from a local audio-video device.

28. A method comprising:
a plurality of video display devices receiving a plurality of audio streams and a plurality of video streams, each of the plurality of video display devices receiving an audio stream that is one of the plurality of audio streams and a video stream that is one of the plurality of video streams, the plurality of video streams being available for viewing on the plurality of video display devices within an environment;
the plurality of video display devices indicating that the plurality of audio streams are available for access;
a video display device receiving a request to access the audio stream that the video display device receives, the video display device being one of the plurality of video display devices; and
in response to the request, the video display device transmitting the audio stream that the video display device receives to a listening device that is physically distinct from the plurality of video display devices;
wherein a user is capable of listening to the audio stream transmitted by the video display device through the listening device while watching the corresponding video stream received by the video display device.

29. The method of claim 28, wherein:
the video stream that the video display device receives is received by the video display device from an audio-video source in a delayed state relative to the audio stream that the video display device receives.

30. A method comprising:
providing an application for running on a personal user device;
the application determining a plurality of audio streams that are available for streaming through the personal user device from at least one video display device that is physically distinct from the personal user device, the application being stored within a memory of the personal user device, the plurality of audio streams corresponding to at least one video stream available for viewing within an environment, wherein the at least one video stream is associated with the at least one video display device;
the application receiving a selection of one of the audio streams from a user, the user having input the selection of the one selected audio stream via the personal user device;
the application transmitting to the at least one video display device a request to access the one selected audio stream;
the application receiving the one selected audio stream; and
the application providing the one selected audio stream through a listening device included in or connected to the personal user device, so that the user is capable of listening to the one selected audio stream through the personal user device while watching the at least one video stream associated with the at least one video display device, the listening device being distinct from the at least one video display device.
